(19) United States
(12) Patent Application Publication
(10) Pub. No.: US 2015/0017302 A1
(43) Pub. Date: Jan. 15, 2015

(54) FRUITY FLAVORED COCOA PRODUCTS AND PROCESSES FOR PRODUCING SUCH COCOA PRODUCTS

(71) Applicant: Harrold Glenn Anijs, Almere (NL)

(72) Inventor: Harrold Glenn Anijs, Almere (NL)

(21) Appl. No.: 14/110,467

(22) PCT Filed: Apr. 9, 2012
(86) PCT No.: PCT/US12/32711

§ 371 Date: Jul. 28, 2014

Related U.S. Application Data
(60) Provisional application No. 61/473,246, filed on Apr. 8, 2011.

(51) Int. Cl. A23G 1/32; A23L 1/235

(52) U.S. Cl. CPC A23G 1/32; A23L 1/235; A23V 2002/00
USPC 426/536; 426/631; 426/538; 426/534; 426/388

(57) ABSTRACT

Cocoa products having a fruity flavor comprising an increased amount of a fruity aroma compounds are disclosed. The cocoa products are produced by a method comprising mixing cocoa nibs, de-shelled cocoa beans, or a combination thereof with an acid and water and roasting the acidified nibs, the acidified de-shelled cocoa beans, or the combination thereof.

### TECHNICAL FIELD

Methods for producing cocoa products with fruity flavors are disclosed. Cocoa products including, without limitation, cocoa powders and cocoa liquors produced according to such methods are also disclosed, as well as food products including such cocoa products.

### BACKGROUND ART

Cocoa bean processing includes fermenting harvested beans, drying the beans, de-hulling the beans to produce nibs, sterilizing the nibs, roasting the nibs, crushing the nibs into cocoa liquor, and optionally pressing the cocoa liquor to obtain cocoa butter and cocoa powder. Variations in this process also are known. Dutched cocoa powder is produced by alkalizing the nibs prior to roasting. Alkalization is a process where nibs are heated in water in the presence of sodium, potassium, ammonium, or magnesium hydroxide or carbonate, for example and without limitation, potash (K₂CO₃). The alkalization process alters the flavor, coloring, and solubility of the cocoa powder in water.

Current commercial demands require a cocoa manufacturer to produce cocoa products in a broad palette of colors, flavors, or both. While each manufacturer understands that manipulation of processing conditions such as temperature, water content, duration of processing time, and pH will affect the color and flavor of the cocoa powder produced, there is no general consensus as to how to produce a cocoa product of a consistently desirable color, flavor, or both.

US Patent Application Publication US 2008/0107783 describes methods of producing bright red, brown, and red-brown cocoa products. Such publication discloses novel colored cocoa products and uses thereof.

International Publication WO 2009/067533 describes a process for producing acidified red cocoa products and ingredients. Such methods are performed on under-fermented or unfermented cocoa beans that are treated with an acid, such as hydrochloric or phosphoric acid.

However, needs continually exist for processes for producing cocoa products having desired colors, flavors or both.

### DISCLOSURE OF INVENTION

In one embodiment, a cocoa product having a fruity flavor comprises an increased amount of a fruity aroma compounds.

In another embodiment, a method for producing a cocoa product having a fruity flavor comprises mixing cocoa nibs, de-shelled cocoa beans, or a combination thereof with an acid and water, and roasting the acidified nibs, the acidified de-shelled cocoa beans, or the combination thereof.

### BRIEF DESCRIPTION OF THE DRAWINGS

FIG. 1 is a spider graph of flavor compounds present in various embodiments of fruity cocoa products of the present invention.

FIG. 2 is a spider graph showing the relative concentrations of six flavor compounds of FIG. 1.

FIG. 3 is a spider graph of flavor compounds present in various embodiments of fruity cocoa products of the present invention.

FIG. 4 is a spider graph showing the relative concentrations of six flavor compounds of FIG. 3.

FIG. 5 is a spider graph of flavor compounds present in various embodiments of fruity cocoa products of the present invention.

FIG. 6 is a spider graph showing the relative concentrations of six flavor compounds of FIG. 5.

FIG. 7 is a spider graph of flavor compounds present in various embodiments of fruity cocoa products of the present invention.

FIG. 8 is a spider graph showing the relative concentrations of six flavor compounds of FIG. 7.

FIG. 9 is a spider graph of flavor compounds present in various embodiments of fruity cocoa products of the present invention.

FIG. 10 is a spider graph of flavor compounds present in various embodiments of fruity cocoa products of the present invention.

FIG. 11 is a graph illustrating the amount of flavor compounds present in various embodiments of fruity cocoa products of the present invention.

FIG. 12 is a spider graph of flavor compounds present in various embodiments of fruity cocoa products of the present invention.

FIG. 13 is a graph illustrating a ratio of flavor compounds present in various embodiments of fruity cocoa products of the present invention as compared to a reference Arriba cocoa product.

FIG. 14 is a spider graph of the ratio of flavor compounds depicted in FIG. 13.

FIG. 15 is a graph illustrating a ratio of flavor compounds present in various embodiments of fruity cocoa products of the present invention as compared to a reference natural cocoa product.

FIG. 16 is a spider graph of the ratio of flavor compounds depicted in FIG. 15.

FIG. 17 is a graph illustrating a ratio of flavor compounds present in various embodiments of fruity cocoa products of the present invention as compared to a reference Arriba cocoa product.

### MODES FOR CARRYING OUT THE INVENTION

In one embodiment, fruity flavored cocoa products are disclosed. The fruity flavored cocoa products have a fresh, fruity flavor and taste.

In one embodiment, a method for producing cocoa products having a fruity flavor is disclosed. The method includes mixing cocoa nibs, de-shelled beans, or a combination thereof with an acid and water, and roasting the acidified cocoa nibs, de-shelled beans, or the combination thereof. In another embodiment, the acidified cocoa nibs, the acidified de-shelled, beans, or the combination thereof is washed with water.

In a further embodiment, the acid is selected from the group consisting of gluconic delta lactone acid, phosphoric acid, ascorbic acid, sodium bisulphate, acid, and combinations of any thereof. The cocoa nibs, the de-shelled beans, or the combination thereof may be good fermented, under fermented, or a combination thereof.

In yet an additional embodiment, the nibs, the de-shelled beans, or the combination thereof are sterilized.

In an additional embodiment, the nibs, the de-shelled beans, or the combination thereof may be in contact with the acid for a period of from about 0.5 to about 4 hours, at a temperature of between about 15° C. to about 90° C., or a combination of such time and temperature.

In another embodiment, the roast cocoa nibs, the roast de-shelled beans, or the combination thereof are roasted to a moisture content of less than about 2%.

In yet a further embodiment, the roast cocoa nibs, the roast de-shelled beans, or the combination thereof are ground, thus producing cocoa liquor. The cocoa liquor may be separated into cocoa butter and cocoa presscake, or the cocoa liquor may be defatted. The cocoa presscake may be further ground into cocoa powder.

After such processing, the beans or nibs may be further roasted and/or ground to cocoa liquor and, optionally, pressed into cocoa powder presscake and cocoa butter. The presscake may be ground to produce cocoa powder. This process yields cocoa products having fruity flavors and such cocoa products may be unusually bright, and typically red, brown and red-brown.

In an additional embodiment, a cocoa product having an increased amount of at least one fruity aroma compound is disclosed. The fruity aroma compound is selected from the group consisting of furaneol, phenylacetaldehyde, ethyl-2-methylpropanoate, ethyl-2-methylbutanoate, ethyl-2-methylbutanoate, and combinations of any thereof.

In a further embodiment, a cocoa product of the present invention comprises an amount of a fruity aroma compound selected from the group consisting of at least 2.5 μg/kg of ethyl-2-methylpropanoate, at least 5 μg/kg of ethyl-2-methylpropanoate, at least 7.5 μg/kg of ethyl-2-methylbutanoate, at least 15 μg/kg of ethyl-2-methylbutanoate, at least 10 μg/kg of ethyl-3-methylbutanoate, at least 20 μg/kg of ethyl-3-methylbutanoate, at least 50 μg/kg of phenylacetaldehyde, at least 100 μg/kg of furaneol, and combinations of any thereof.

In another embodiment, the fruity flavored cocoa products of the present invention are cocoa powder, cocoa liquor, cocoa butter, or combinations of any thereof.

In another embodiment, the cocoa products of the present invention are desirable since the cocoa products have an increase in fruity flavors, yet have less bitterness. The bitterness may be associated with compounds such as polyphenols, pyrazines, non-volatile compounds, and combinations of any thereof. Thus, in another embodiment, cocoa products produced from good fermented cocoa beans having fruitier flavor and less bitterness as compared to cocoa products produced from under fermented or unfermented cocoa beans are disclosed. In another embodiment, the cocoa products of the present invention have less than 500 μg/kg of acrylamide, or less than 250 μg/kg of acrylamide.

Fruity flavored cocoa products are desired in certain food applications. For instance, fruity cocoa products may fit well with yoghurt flavored food products or other food flavors. In one embodiment, the cocoa products of the present invention have an increased amount of fruity aroma compounds or fruity compounds as compared to conventional cocoa products. Fruity aroma compounds include, but are not limited to, furaneol, phenylacetaldehyde, ethyl-2-methylpropanoate, ethyl-2-methylbutanoate, ethyl-2-methylbutanoate, and combinations of any thereof.

In another embodiment, the fruity flavored cocoa products of the present invention may have a bright color which refers to cocoa products with a C value more than about 18.0, 19.0, 20.0, 21.0, 22.0, 23.0, 24.0, 25.0, or higher, inclusive of intervals between those values. In another embodiment, the fruity flavored cocoa products of the present invention are red, redder, or more red which refers to a cocoa product having an H value approximately in the range of from about 35 to about 55, about 40 to about 45, or about 48 to about 56, (CIE 1976) that has an H value less than another, reference cocoa powder. In another embodiment, the fruity flavored cocoa products of the present invention are brown, browner, or more brown and refer to a cocoa product with an H value approximately in the range of from about 45 to about 55 (CIE 1976) that has an H value greater than another, reference cocoa powder.

In yet an additional embodiment, a fruity flavored cocoa product of the present invention has a color value selected from the group consisting of an L value of between about 18 to about 29, an L value of between about 22 to about 29, a C value of about 23 to about 30, an H value of between about 35 to about 55, and combinations of any thereof. Further, the fruity flavored cocoa product of the present invention may have a pH of between about 3 to about 6, a pH of between about 4.5 to about 6, or a pH of between about 4.5 to 5.

In one embodiment, a starting material for the processes described herein may be de-shelled cocoa beans which refers to any suitable cocoa bean fraction/product having the shells substantially removed, broken, and/or winnowed. Non-limiting examples of de-shelled cocoa beans include, but are not limited to, nibs, kernels, and cotyledons. De-shelled cocoa beans typically contain a small fraction of contaminating shells that are within commercially acceptable tolerances since no de-shelling process is 100% complete.

In another embodiment, a pH of the de-shelled cocoa beans may be manipulated by placing an acidic or alkaline agent in contact with the de-shelled cocoa beans. Optionally, after the acidic or alkaline agent is placed in contact with the de-shelled cocoa beans, the de-shelled cocoa beans may be washed. Alkalization agents are known in the art, and may include, but are not limited to, water and sodium, potassium, ammonium or magnesium hydroxide or carbonate, potash (K₂CO₃), and combinations of any thereof. Acid agents are known in the art and may include, without limitation food grade acids or organic acids. Examples of food grade acids include, but are not limited to, hydrochloric acid, sodium acid sulfate, sodium bisulphate acid, sodium acid phosphate, phosphoric acid, and combinations of any thereof. Examples of organic acids include, but are not limited to, gluconic acid, gluconic delta lactone acid, ascorbic acid, citric acid, lactic acid, lemon juice, lime juice, acetic acid, fumaric acid, adipic acid, malic acid, tartaric acid, and combinations of any thereof.

In an additional embodiment, the cocoa beans used to produce the fruity flavored cocoa products of the present invention are good fermented. In a further embodiment, the cocoa beans used to produce the fruity flavored cocoa products of the present invention are under- or un-fermented.

In a further embodiment, another process parameter that may help achieve optimal coloring of the fruity flavored cocoa product is to minimize sterilization of the beans or nibs prior to pH manipulation.

In one embodiment, the fruity flavored cocoa products produced herein are suitable for many commercial purposes, including, without limitation, food products. Examples of food products include, but are not limited to, chocolate, dark chocolate, milk chocolate, semi-sweet-chocolate, baking chocolate, candies, pralines, truffles, candy bars, flavoring syrup, confectionery coatings, compound coatings, fillings, beverages, milk, ice cream, beverage mixes, smoothies, soy milk, cakes, cheesecakes, cookies, pies, diet bars, meal-substitute solid foods and beverages, energy bars, chocolate chips, yogurt, yogurt drinks, pudding, mousse, mole, chocolates with lower bitterness, chocolate with fillings such as yogurt, cheesecake or fruit, and cocoa powders for use in cheese, dairy or beverages.

In another embodiment, fruity flavored cocoa products including, without limitation, powders and/or liquors having extraordinary brightness are produced by the methods described herein. The fruity flavored cocoa products may have an L color coordinate value greater than 16 or in a range of 22-29, a pH less than 7.0 or in a range of 3.0-6.0, and exhibit a high brightness expressed by a C color coordinate value greater than 20 or in a range of 23-30. H-values (CIE 1976) may fall in the red-to-brown range of between 35-55.

A number of objective methods for measuring the color of cocoa products are known. In one method, the Hunter color system or CIE 1976 (CIELAB) and like systems, color may be described in terms of three parameters: Lightness (L)—the light or dark aspect of a color, where the lower the L-value, the darker the cocoa powder will appear; Chroma (C)—the intensity of a color by which one distinguishes a bright or gray color, where the higher the C-value, the brighter the powder will be; and Hue (H)—referring to color in daily speech, such as red, yellow, or blue. For cocoa powders, a low H value indicates a red color and a high H-value indicates a brown color.

The CIE 1976 color system describes colors in terms of coordinates L, “a*” and “b*”. The L coordinate is consistent with the Value of Lightness, and from the a* and b* coordinates, the Chroma and Hue can be calculated as follows: C*=\sqrt{a*²+b*²}; H=arctan(b*/a*).

The spectral color is the result of the source of light and the reflecting surface. For a good reproducible measurement of color, the source of light is standardized. There are two basic approaches for measuring color: visually or by instrumentation. There is a natural human tendency to trust only “one's own eyes.” For this reason, colors are still frequently judged visually. To be able to do this in a reproducible manner, certain standard conditions should be met: the light source, for example and without limitation, a CIE standard light source; the positions of the sample, relative to the light source, which are preferably at an angle of 45° to each other; the background of the sample, uniform and preferably gray; the distance between the eyes and the sample and position of the eyes relative to the sample; and the size of the sample.

In practice, color cabinets are used with standard light sources for visual color determinations. Color meters and spectrophotometers are used for instrument color readings. Instrument color measurements were made in the Examples herein using a Datacolor Spectraflash 500 Color spectrophotometer in the manner described herein. Unless otherwise indicated, the color values described in the Examples, and all reference herein to color values L, C, H, a and b (a* and b*, respectively), are readings using the Datacolor Spectraflash 500 Color spectrophotometer. The color parameters described herein refer to the L, C, H parameters that can be calculated from L, a and b readings according to the CIE 1976 system. The color values recited herein are approximate in the sense that color measurements may vary from spectrophotometer-to-spectrophotometer, typically in the range of +/−0.5 for L, C and H values. Therefore, the stated values for L, C and H are intended to include such variation inherent between spectrophotometers. The color values of cocoa powders, unless indicated otherwise, are obtained on samples of pulverized cocoa cakes (post pressing to remove cocoa butter) in water.

The following examples illustrate various non-limiting embodiments of the compositions within the present disclosure and are not restrictive of the invention as otherwise described or claimed herein.

### EXAMPLES

### Example 1

### Production of Cocoa Products with Ascorbic Acid

Under fermented Sulawesi beans were used to produce 2,000 grams of under-fermented nibs. The nibs were mixed with 3,000 mL of a 0.5M ascorbic acid solution having a temperature of 25° C. in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a stove with rotating air at a temperature of 50° C. for 20 hours to reduce the moisture content to the range of 3-5%. The dried nibs were roasted in a Retch fluidized bed dryer (i.e., jet roaster) for 15 minutes at a temperature of 110° C. to lower the moisture to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 2

### Production of Cocoa Products with Ascorbic Acid

Under fermented Sulawesi beans were used to produce 2,000 grams of under-fermented nibs. The nibs were mixed with 3,000 mL of a 0.5M ascorbic acid solution having a temperature of 25° C. in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a Retch fluidized bed dryer (i.e., jet roaster) for 75 minutes at a temperature of 120° C. to reduce the moisture content to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 3

### Production of Cocoa Products with Gluconic Delta Lactone Acid Solution

Under fermented Sulawesi beans were used to produce 2,000 grams of under-fermented nibs. The nibs were mixed with 3,000 mL of a 0.5 M gluconic delta lactone acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a stove with rotating air at a temperature of 50° C. for 20 hours to reduce the moisture content to the range of 3-5%. The dried nibs were roasted in a Retch fluidized bed dryer (i.e., jet roaster) for 15 minutes at a temperature of 110° C. to lower the moisture to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 4

### Production of Cocoa Products with Gluconic Delta Lactone Acid Solution

Under fermented Sulawesi beans were used to produce 2,000 grams of under-fermented nibs. The nibs were mixed with 3,000 mL of a 0.5 M gluconic delta lactone acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a Retch fluidized bed dryer (i.e., jet roaster) for 75 minutes at a temperature of 120° C. to reduce the moisture content to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 5

### Production of Cocoa Products with Sodium Bisulphate Acid Solution

Under fermented Sulawesi beans were used to produce 2,000 grams of under-fermented nibs. The nibs were mixed with 3,000 mL of a 0.5 M sodium bisulphate acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a stove with rotating air at a temperature of 50° C. for 20 hours to reduce the moisture content to the range of 3-5%. The dried nibs were roasted in a Retch fluidized bed dryer (i.e., jet roaster) for 15 minutes at a temperature of 110° C. to lower the moisture to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm

### Example 6

### Production of Cocoa Products with Sodium Bisulphate Acid Solution

Under fermented Sulawesi beans were used to produce 2,000 grams of under-fermented nibs. The nibs were mixed with 3,000 mL of a 0.5 M sodium bisulphate acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a Retch fluidized bed dryer (i.e., jet roaster) for 75 minutes at a temperature of 120° C. to reduce the moisture content to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 7

### Production of Cocoa Products with Phosphoric Acid

Under fermented Sulawesi beans were used to produce 2,000 grams of under-fermented nibs. The nibs were mixed with 3,000 mL of a 0.16 M phosphoric acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a stove with rotating air at a temperature of 50° C. for 20 hours to reduce the moisture content to the range of 3-5%. The dried nibs were roasted in a Retch fluidized bed dryer (i.e., jet roaster) for 15 minutes at a temperature of 110° C. to lower the moisture to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 8

### Production of Cocoa Products with Phosphoric Acid

Under fermented Sulawesi beans were used to produce 2,000 grams of under-fermented nibs. The nibs were mixed with 3,000 mL of a 0.16 M phosphoric acid solution having a temperature of 25° C. were mixed in a plastic bucket having a volume of eight liters. After stirring, the nibs in the acid solution were placed in a stove with rotating air at a temperature of 25° C. for four hours.

The wet, acidified nibs were drained to remove the excess acid solution. The drained nibs were rinsed several times with tap water until the pH of the watery residue coming off of the rinsed nibs was in the range of 3.2-5.0. After rinsing, the moisture content of the nibs was in the range of 44-50%.

The washed nibs were dried in a Retch fluidized bed dryer (i.e., jet roaster) for 75 minutes at a temperature of 120° C. to reduce the moisture content to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

### Example 9

### Production of Reference or Control Cocoa Product

Under fermented Sulawesi beans were used to produce 2,000 grams of under-fermented nibs. These nibs were not placed in contact with an acid solution as described in Examples 1-8.

The nibs were dried in a Retch fluidized bed dryer (i.e., jet roaster) for 75 minutes at a temperature of 120° C. to reduce the moisture content to 1-2%.

The roasted nibs were ground to coarse liquor in a household coffee mill, and further ground to cocoa liquor of a desired fineness in a Retsch laboratory mortar mill.

A first portion of the fine ground liquor was extracted to obtain a fat free cocoa powder and a second portion of the fine ground liquor was hydraulic pressed into small cakes and filtered cocoa butter. The cakes were broken into small pieces and the pieces were pulverized into cocoa powder with a Retsch cutting mill with sieves having holes of 0.5 mm.

Tables 1A and 1B show the process conditions used to produce the cocoa products of Examples 1-9.

TABLE 1A
Process conditions of cocoa products of Examples
1-4 and the control or reference, Example 9.

| Example number | Ex. 1 | Ex. 2 | Ex. 3 | Ex. 4 | Ex. 9 |
|---|---|---|---|---|---|
| nibs from 100% Bad fermented | | | | | |
| Sulawesi beans | | | | | |
| Charge Weight (g) | 2000 | 2000 | 2000 | 2000 | 2000 |
| moisture content (%) | 6.4 | 6.4 | 6.4 | 6.4 | 6.4 |
| Fat content (%) | 50.5 | 50.5 | 50.5 | 50.5 | 50.5 |
| Butter of Sulawesi nib | | | | | |
| Free Fatty Acid content (%) | 1.1 | 1.1 | 1.1 | 1.1 | 1.1 |
| Iodine value | 36.2 | 36.2 | 36.2 | 36.2 | 36.2 |
| Acidification with acid solution during | | | | | |
| 4 hrs | | | | | |
| 3000 g of acid solution (25° C.) | Ascorbic | Ascorbic | GDL | GDL | |
| Acid solution (w %) | 8.1 | 8.1 | 8.2 | 8.2 | |
| Molarity (M) of acid solution | 0.5 | 0.5 | 0.5 | 0.5 | |
| (mol/liter) | | | | | |
| Specific weight (gram/liter) | 1039.3 | 1039.3 | 1051.1 | 1051.1 | |
| pH | 2.22 | 2.22 | 2.01 | 2.01 | |
| Charges of tap water for washing the nib | | | | | |
| Tap water for every washing step | 3000 | 3000 | 3000 | 3000 | |
| of the nibs (g) | | | | | |
| Temperature tap water (° C.) | 21.6 | 21.6 | 20 | 20 | |
| pH of the tap water | 6.32 | 6.32 | 6.32 | 6.32 | |
| pH of the Watery residue | | | | | |
| after 4 hours acidification | 3.72 | 3.72 | 3.37 | 3.37 | |
| after first washing with tapwater | 3.88 | 3.88 | 3.55 | 3.55 | |
| after second washing with tap water | 3.97 | 3.97 | 3.66 | 3.66 | |
| after third washing with tap water | 4.07 | 4.07 | 3.75 | 3.75 | |
| Drying methods of the wet acidified nibs | Stove | Jet roast | Stove | Jet roast | Jet roast |
| Moisture content of the nib (%): | | | | | |
| Raw unacidified nibs (w %) | 6.4 | 6.4 | 6.4 | 6.4 | 6.4 |
| After washings with water | 46.6 | 46.6 | 44.9 | 44.9 | 13.5 |
| After 20 hrs drying at 50° C. in the stove | 4.26 | | 4.9 | | |
| After 75 min Jet roasting at 120° C. | | 1.8 | | 1.9 | |
| (SP is 120° C.) | | | | | |
| After 25 min jet roasting at 100° C. | <1 | <1 | <1 | <1 | <1 |
| (before grinding) | | | | | |

TABLE 1B
Process conditions of cocoa products of Examples 5-8 and the control, Example 9.

| Example number | Ex. 5 | Ex. 6 | Ex. 7 | Ex. 8 | Ex. 9 |
|---|---|---|---|---|---|
| nibs from 100% Sulawesi beans | | | | | |
| (bad fermented) | | | | | |
| Charge Weight (g) | 2000 | 2000 | 2000 | 2000 | 2000 |
| moisture content (%) | 6.4 | 6.4 | 6.4 | 6.4 | 6.4 |
| Fat content (%) | 50.5 | 50.5 | 50.5 | 50.5 | 50.5 |
| Butter of raw nib | | | | | |
| Free Fatty Acid content (%) | 1.1 | 1.1 | 1.1 | 1.1 | |
| Iodine value | 36.2 | 36.2 | 36.2 | 36.2 | |
| Acidification with acid solution during | | | | | |
| 4 hrs | | | | | |
| 3000 g of acid solution (25° C.) | NaHSO4 | NaHSO4 | H3PO4 | H3PO4 | |
| Acid solution (w %) | 5.7 | 5.7 | 1.6 | 1.6 | |
| Molarity (M) of acid solution (mol/liter | 0.51 | 0.51 | 0.16 | 0.16 | |
| Specific weight (gram/liter) | 1042.5 | 1042.5 | 1026.4 | 1026.4 | |
| pH | 0.86 | 0.86 | 1.45 | 1.45 | |
| Charges of tap water for washing the nib | | | | | |
| Tap water for every washing step of the | 3000 | 3000 | 3000 | 3000 | |
| nibs (g) | | | | | |
| Temperature tap water (° C.) | 21.6 | 21.6 | 21.6 | 21.6 | |
| pH of the tap water | 6.32 | 6.32 | 6.32 | 6.32 | |
| pH of the Watery residue | | | | | |
| after 4 hours acidification | 1.63 | 1.63 | 3.64 | 3.64 | |
| after first washing with tap water | 2.12 | 2.12 | 4.09 | 4.09 | |
| after second washing with tap water | 2.32 | 2.32 | 4.58 | 4.58 | |
| after third washing with tap water | 2.52 | 2.52 | 4.99 | 4.99 | |
| after fourth washing with tap water | 2.68 | 2.68 | 5.06 | 5.06 | |
| after five washing with tap water | 2.82 | 2.82 | | | |
| after six washing with tap water | 2.96 | 2.96 | | | |
| after seven washing with tap water | 3.21 | 3.21 | | | |
| after eight washing with tap water | 3.45 | 3.45 | | | |
| after Nine washings with tap water | 3.72 | 3.72 | | | |
| Drying methods of the wet acidified nibs | Jet Roast | Stove | Jet roast | Stove | Jet roast |
| Moisture content of the nib (%): | | | | | |
| Raw un acidified nibs (w %) | 6.4 | 6.4 | 6.4 | 6.4 | 6.4 |
| After washings with water | 47.6 | 47.6 | 43.5 | 43.5 | 13.5 |
| After 20 hrs drying at 50° C. in the stove | | 4.2 | | 4.3 | |
| After 75 min Jet roasting at 120° C. | 2.5 | | 2.5 | | |
| (SP is 120° C.) | | | | | |
| After 25 min jet roasting at 100° C. | <1 | <1 | <1 | <1 | <1 |
| (before grinding) | | | | | |

The cocoa liquor, cocoa powder and cocoa butter produced in Examples 1-9 were characterized as shown in Table 2.

TABLE 2
Color of cocoa liquor and cocoa powder of Examples 1-9.

| Example number | 1 | 2 | 3 | 4 | 5 | 6 | 7 | 8 | 9 |
|---|---|---|---|---|---|---|---|---|---|
| Acid | Ascorbic | Ascorbic | GDL | GDL | NaHSO₄ | NaHSO₄ | H₃PO₄ | H₃PO₄ | |
| Drying in stove | X | | X | | | X | | X | |
| Drying in jet | | X | | X | X | | X | | |
| roaster | | | | | | | | | |
| Liquor | | | | | | | | | |
| Intrinsic Colour | | | | | | | | | |
| FFD (in water) | | | | | | | | | |
| L ffd | 27.58 | 25.44 | 25.51 | 23.65 | 23.18 | 25.58 | 23.30 | 24.28 | 23.26 |
| C ffd | 27.00 | 25.73 | 23.77 | 23.98 | 27.26 | 27.32 | 23.54 | 24.17 | 23.85 |
| H ffd | 52.14 | 50.09 | 48.32 | 48.53 | 42.25 | 39.44 | 49.02 | 50.67 | 53.31 |
| a ffd | 16.57 | 16.51 | 15.80 | 15.88 | 20.18 | 21.09 | 15.44 | 15.31 | 14.25 |
| b ffd | 21.32 | 19.74 | 17.75 | 17.97 | 18.33 | 17.35 | 17.77 | 18.69 | 19.12 |
| Powder | | | | | | | | | |
| pH | 4.52 | 4.53 | 4.38 | 4.48 | 3.4 | 3.47 | 4.76 | 4.72 | 5.96 |
| % moisture | 2.37 | 2.56 | 2.35 | 2.26 | 2.41 | 2.55 | 2.31 | 2.83 | 2.07 |
| % fat | 15.67 | 13.88 | 14.92 | 12.98 | 13.78 | 13.93 | 13.56 | 16.68 | 15.11 |
| Intrinsic Colour | | | | | | | | | |
| (in water) | | | | | | | | | |
| L tot | 30.13 | 27.67 | 27.87 | 25.64 | 25.26 | 27.78 | 25.37 | 26.94 | 25.53 |
| C tot | 27.89 | 26.56 | 24.55 | 24.75 | 28.12 | 28.05 | 24.34 | 25.17 | 24.80 |
| H tot | 52.74 | 50.57 | 48.80 | 48.91 | 42.57 | 39.76 | 49.42 | 51.22 | 53.74 |
| a tot | 16.88 | 16.87 | 16.17 | 16.27 | 20.71 | 21.57 | 15.84 | 15.77 | 14.67 |
| b tot | 22.2 | 20.52 | 18.47 | 18.65 | 19.02 | 17.94 | 18.49 | 19.62 | 20.00 |
| filtered Butter | | | | | | | | | |
| Free fatty acid | 1.02 | 1.00 | 1.00 | 0.99 | 1.08 | 1.03 | 1.00 | 0.94 | 1.06 |
| (VVZ) | | | | | | | | | |
| Iodine value(I.V.) | 36.2 | 36.3 | 36.2 | 36.2 | 36.2 | 36.2 | 36.3 | 36.3 | 36.1 |

Table 2 indicates that the strength of the acid solution and the drying method has an influence on the color and on the pH of the cocoa product produced. Also, drying in the jet roaster appears to make the final color darker and redder. The stronger acid solution also makes the color of the powders brighter and redder.

The color values L, C, and H were determined for the cocoa products of Examples 1-9 using the CIE LAB data color system. Such colors were also transformed into the color values L, a, and B of the Hunter Lab color system. These colors are shown in Table 3.

TABLE 3
Color values of cocoa products of Examples
1-8 and the control, Example 9.

| | Example | | | | | | | | |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| pH | 4.52 | 4.53 | 4.38 | 4.48 | 3.4 | 3.47 | 4.76 | 4.72 | 5.96 |
| CIE lab | | | | | | | | | |
| L tot | 30.13 | 27.67 | 27.87 | 25.64 | 25.26 | 27.78 | 25.37 | 26.94 | 25.53 |
| C tot | 27.89 | 26.56 | 24.55 | 24.75 | 28.12 | 28.05 | 24.34 | 25.17 | 24.80 |
| H tot | 52.74 | 50.57 | 48.80 | 48.91 | 42.57 | 39.76 | 49.42 | 51.22 | 53.74 |
| a tot | 16.88 | 16.87 | 16.17 | 16.27 | 20.71 | 21.57 | 15.84 | 15.77 | 14.67 |
| b tot | 22.2 | 20.52 | 18.47 | 18.65 | 19.02 | 17.94 | 18.49 | 19.62 | 20.00 |
| Hunter | | | | | | | | | |
| lab | | | | | | | | | |
| L tot | 25.08 | 23.10 | 23.26 | 21.51 | 21.21 | 23.19 | 21.30 | 22.52 | 21.42 |
| C tot | 15.50 | 14.61 | 13.82 | 13.50 | 15.99 | 16.79 | 13.19 | 13.71 | 13.00 |
| H tot | 48.31 | 46.00 | 45.72 | 44.78 | 36.63 | 35.26 | 45.45 | 47.31 | 49.57 |
| a tot | 10.31 | 10.15 | 9.65 | 9.58 | 12.84 | 13.71 | 9.25 | 9.29 | 8.43 |
| b tot | 11.58 | 10.51 | 9.89 | 9.51 | 9.54 | 9.70 | 9.40 | 10.08 | 9.89 |

An analysis was done on the cocoa powders produced in Examples 1-9. The results are shown in Tables 4A and 4B.

TABLE 4A
Lab analysis results on cocoa powders of
Examples 1-4 and the control, Example 9.

| Example number | Ex. 1 | Ex. 2 | Ex. 3 | Ex. 4 | Ex. 9 |
|---|---|---|---|---|---|
| Type drying process | Jet roast | Stove | Stove | Jet roast | Jet roast |
| Potassium as K (%) | 0.5 | 0.5 | 0.49 | 0.47 | 2.0 |
| Sodium as Na (%) | 0.0068 | 0.0079 | 0.0047 | 0.0048 | 0.027 |
| Ash content (%) | 2.92 | 2.98 | 2.82 | 2.92 | 6.36 |
| Total alkalinity (ml/100 g) | 30.54 | 31.7 | 25.83 | 26.16 | 75.12 |
| Total Iron as Fe (mg/kg) | 41 | 42 | 48 | 46 | 59 |
| Aluminium as Al (mg/kg) | 31 | 29 | 22 | 20 | 51 |
| Silicium as Si (%) | <0.01 | <0.01 | <0.01 | <0.01 | 0.02 |
| Phosphorous as P (%) | 0.54 | 0.55 | 0.61 | 0.35 | 0.89 |
| Sulphate as SO4 (%) | <0.2 | <0.2 | <0.2 | <0.2 | <0.2 |
| Ochratoxin A (ug/kg) | <0.4 | <0.4 | <0.4 | <0.4 | <0.4 |
| Acrylamide (ug/kg) | 100 | 160 | 170 | 190 | 830 |
| Acetic acid (%) | 0.05 | 0.06 | 0.06 | 0.06 | 0.26 |
| Citric acid (%) | 0.47 | 0.38 | 0.44 | 0.33 | 1.53 |
| Lactic acid (%) | 0.05 | 0.05 | 0.07 | 0.05 | 0.26 |

TABLE 4B
Lab analysis results on cocoa powders of
Examples 5-8 and the control, Example 9.

| Example number | Ex. 5 | Ex. 6 | Ex. 7 | Ex. 8 | Ex. 9 |
|---|---|---|---|---|---|
| Type drying process | Jet roast | Stove | Jet roast | Stove | Jet roast |
| Potassium as K (%) | 0.15 | 0.18 | 0.59 | 0.54 | 2.0 |
| Sodium as Na (%) | 0.1 | 0.11 | 0.027 | 0.024 | 0.027 |
| Ash content (%) | 2.02 | 2.04 | 3.63 | 3.46 | 6.36 |
| Total alkalinity (ml/100 g) | 13.78 | 12.46 | 24.71 | 26.58 | 75.12 |
| Total Iron as Fe (mg/kg) | 60 | 62 | 49 | 47 | 59 |
| Aluminium as Al (mg/kg) | 22 | 24 | 22 | 26 | 51 |
| Silicium as Si (%) | <0.01 | <0.01 | <0.01 | <0.01 | 0.02 |
| Phosphorous as P (%) | 0.43 | 0.45 | 0.61 | 0.41 | 0.89 |
| Sulphate as SO4 (%) | <0.2 | <0.2 | <0.2 | <0.2 | <0.2 |
| Ochratoxin A (ug/kg) | <0.4 | <0.4 | <0.4 | <0.4 | <0.4 |
| Acrylamide (ug/kg) | 140 | 85 | 280 | 320 | 830 |
| Acetic acid (%) | 0.05 | 0.03 | 0.07 | 0.07 | 0.26 |
| Citric acid (%) | 0.11 | 0.22 | 0.4 | 0.45 | 1.53 |
| Lactic acid (%) | 0.02 | 0.02 | 0.06 | 0.06 | 0.26 |

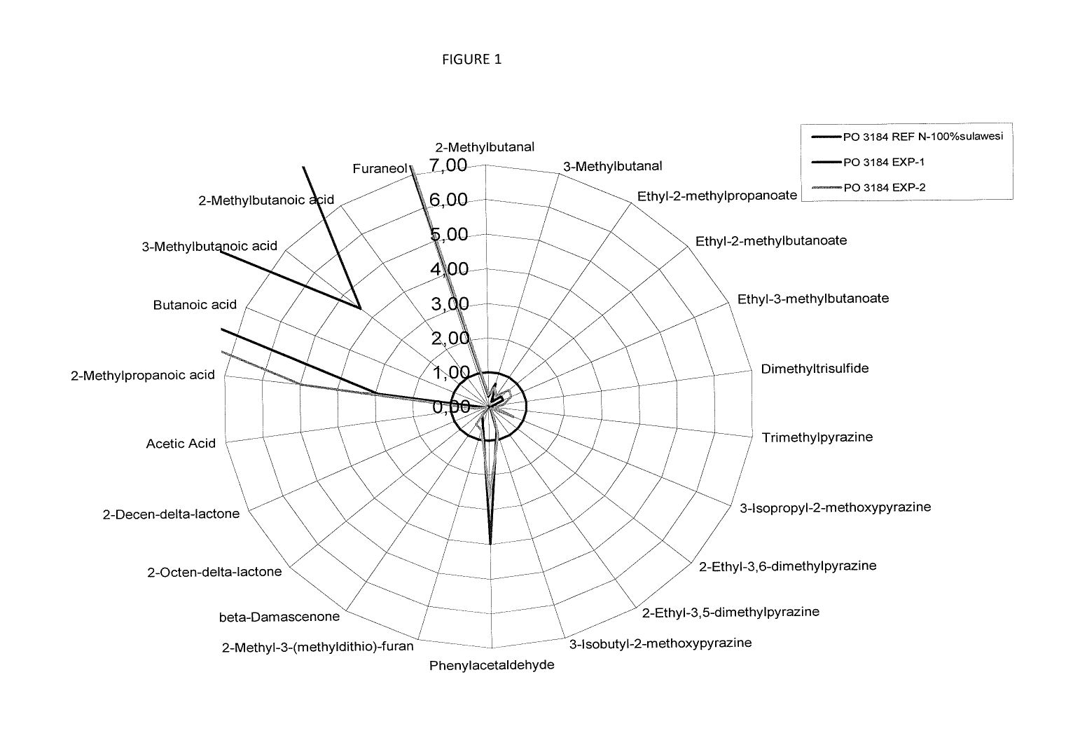

FIG. 1 shows a flavor profile of compounds present in the cocoa liquors produced in Ex. 1, Ex. 2, and the control, Ex. 9. Gas chromatography and mass spec was used to determine the amount of the compounds shown in FIG. 1. The graph in FIG. 1 shows ratios of the concentrations of compounds present in the cocoa liquors of Ex. 1, Ex. 2, and the control, Ex. 9.

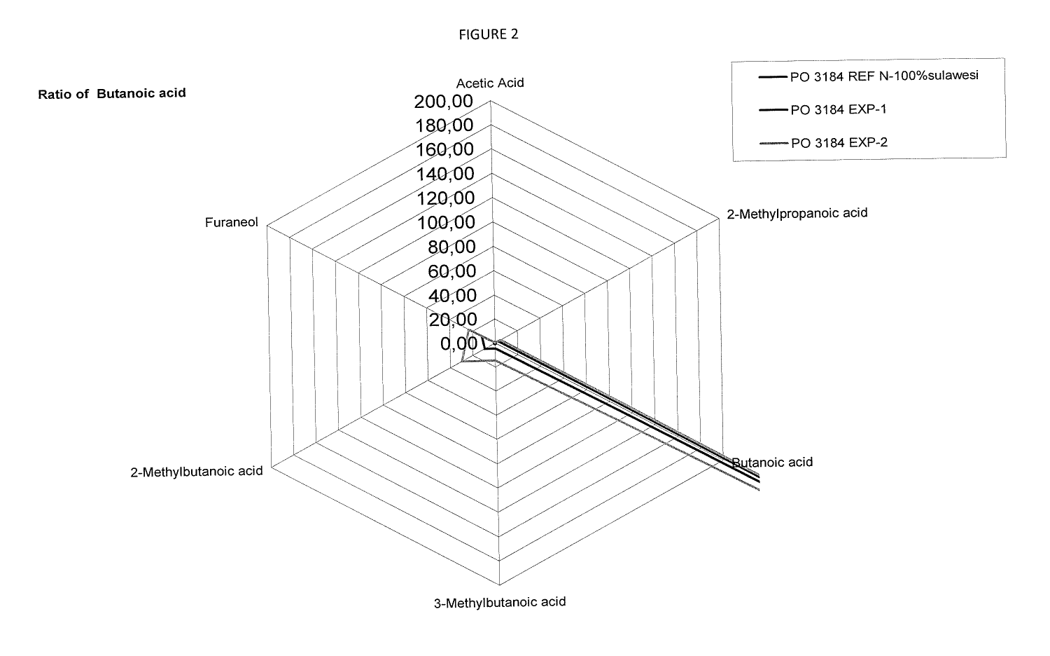

FIG. 2 shows a flavor profile of six compounds present in the cocoa liquors produced in Ex. 1, Ex. 2, and the control, Ex. 9. Gas chromatography and mass spec was used to determine the amount of the compounds shown in FIG. 2. The graph in FIG. 2 shows ratios of the concentrations of compounds present in the cocoa liquors of Ex. 1, Ex. 2, and the control, Ex. 9.

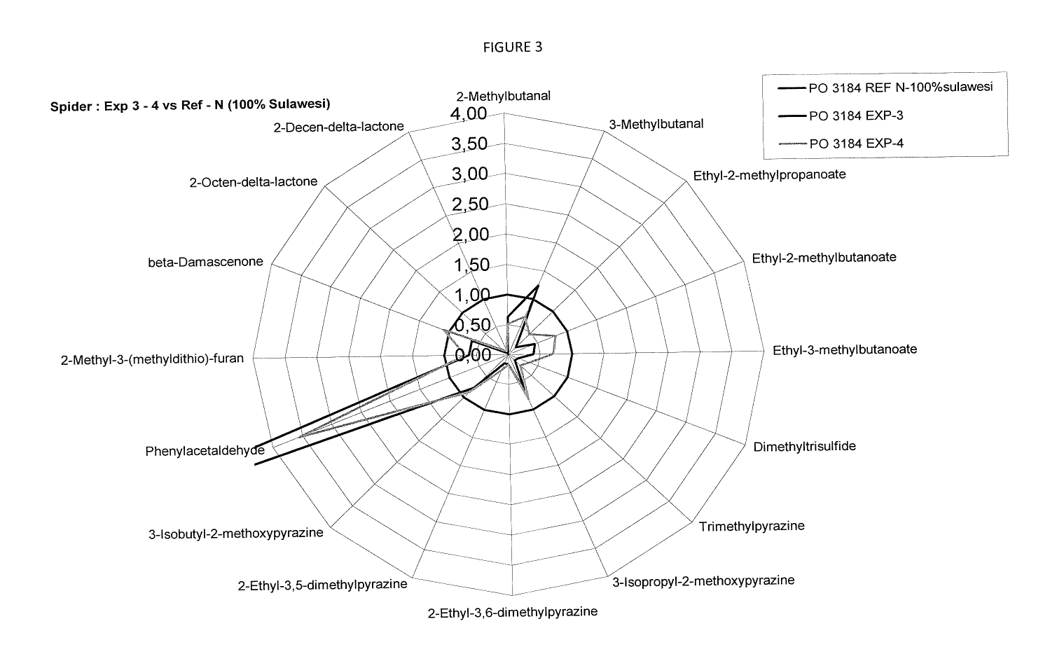

FIG. 3 shows a flavor profile of compounds present in the cocoa liquors produced in Ex. 3, Ex. 4, and the control, Ex. 9. Gas chromatography and mass spec was used to determine the amount of the compounds shown in FIG. 3. The graph in FIG. 3 shows ratios of the concentrations of compounds present in the cocoa liquors of Ex. 3, Ex. 4, and the control, Ex. 9.

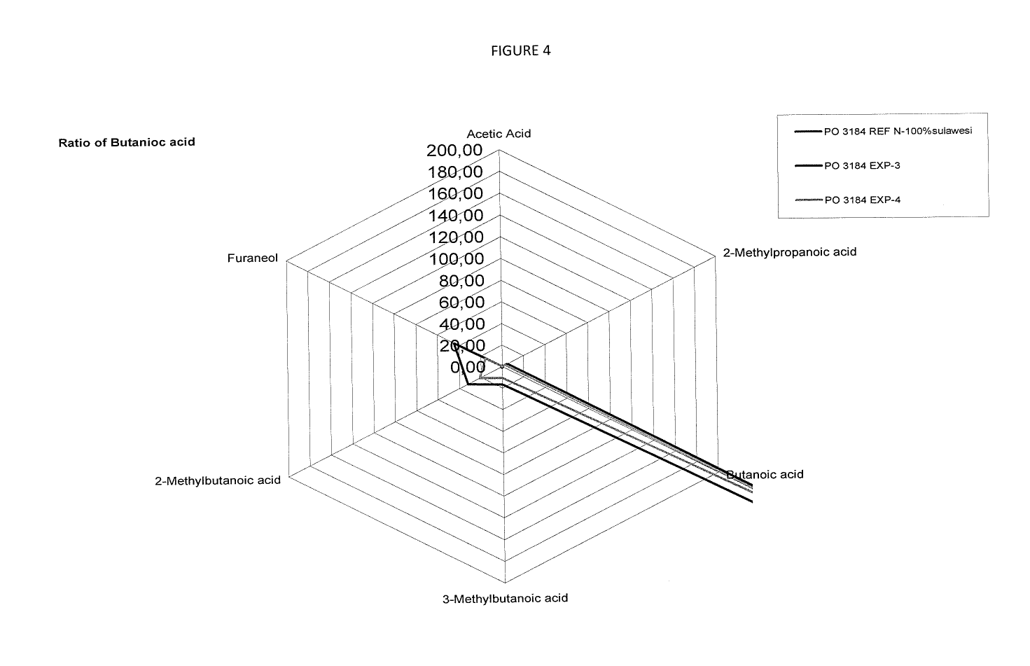

FIG. 4 shows a flavor profile of six compounds present in the cocoa liquors produced in Ex. 3, Ex. 4, and the control, Ex. 9. Gas chromatography and mass spec was used to determine the amount of the compounds shown in FIG. 4. The graph in FIG. 4 shows ratios of the concentrations of compounds present in the cocoa liquors of Ex. 3, Ex. 4, and the control, Ex. 9.

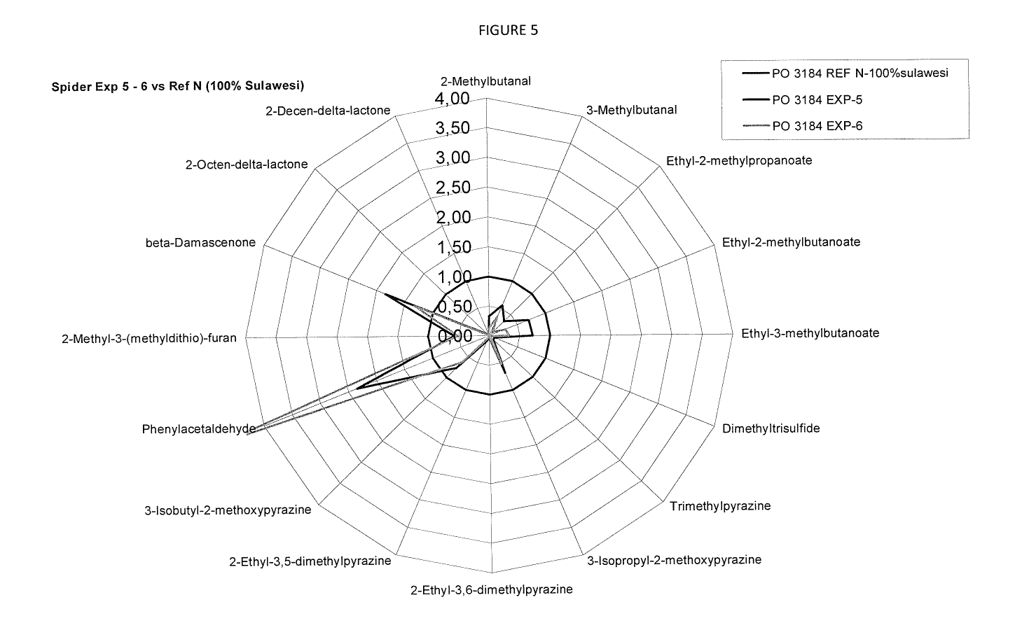

FIG. 5 shows a flavor profile of compounds present in the cocoa liquors produced in Ex. 5, Ex. 6, and the control, Ex. 9. Gas chromatography and mass spec was used to determine the amount of the compounds shown in FIG. 5. The graph in FIG. 5 shows ratios of the concentrations of compounds present in the cocoa liquors of Ex. 5, Ex. 6, and the control, Ex. 9.

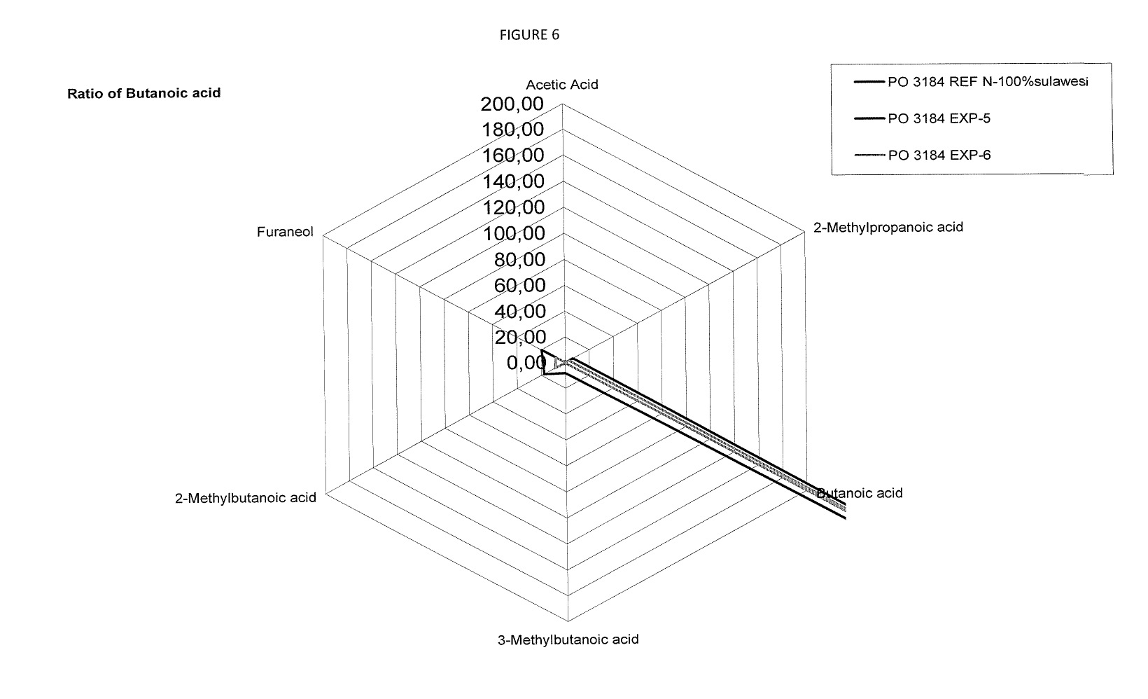

FIG. 6 shows a flavor profile of six compounds present in the cocoa liquors produced in Ex. 5, Ex. 6, and the control, Ex. 9. Gas chromatography and mass spec was used to determine the amount of the compounds shown in FIG. 6. The graph in FIG. 6 shows ratios of the concentrations of compounds present in the cocoa liquors of Ex. 5, Ex. 6, and the control, Ex. 9.

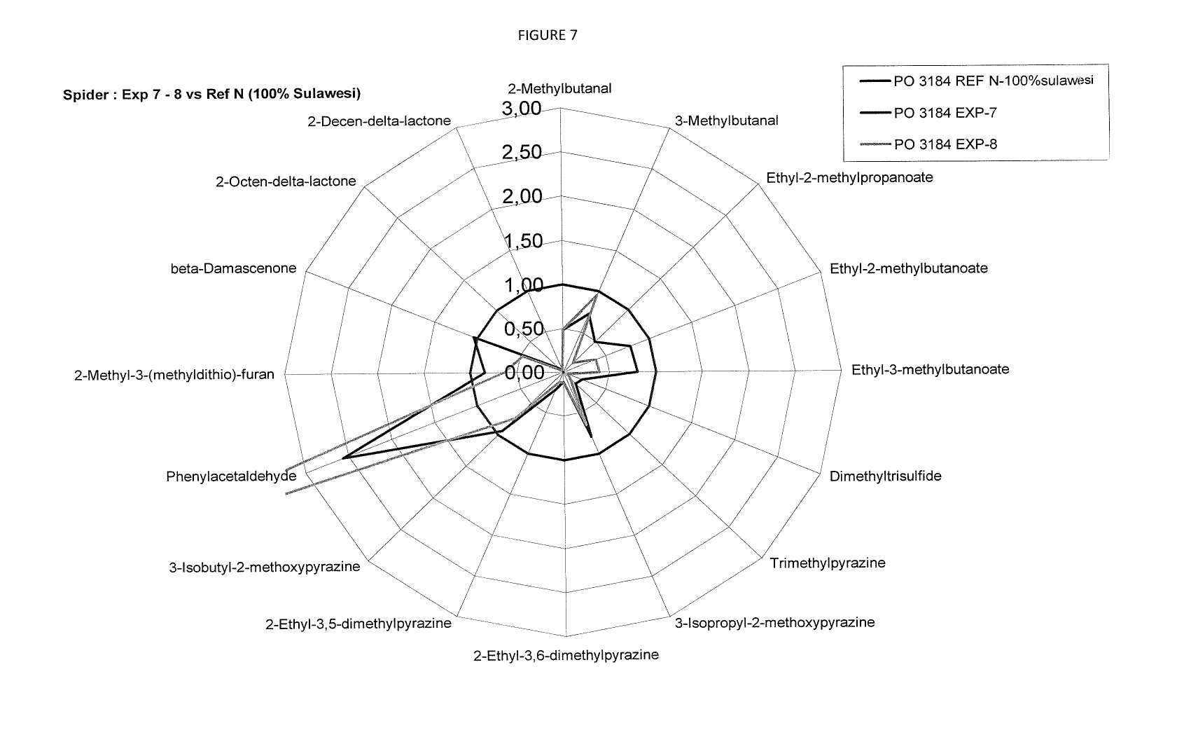

FIG. 7 shows a flavor profile of compounds present in the cocoa liquors produced in Ex. 7, Ex. 8, and the control, Ex. 9. Gas chromatography and mass spec was used to determine the amount of the compounds shown in FIG. 7. The graph in FIG. 7 shows ratios of the concentrations of compounds present in the cocoa liquors of Ex. 7, Ex. 8, and the control, Ex. 9.

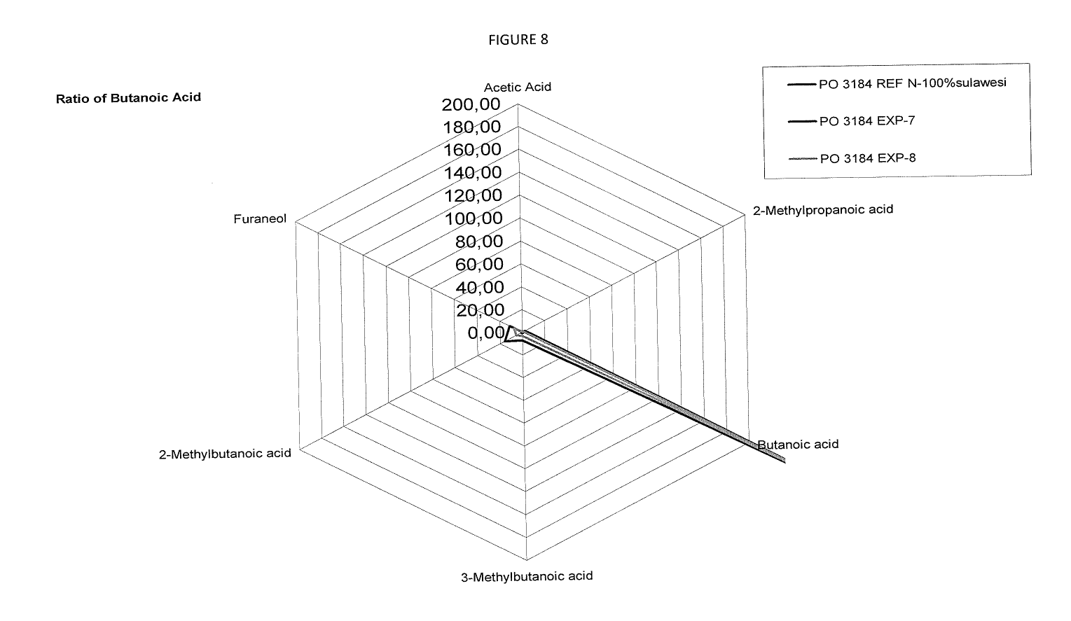

FIG. 8 shows a flavor profile of six compounds present in the cocoa liquors produced in Ex. 7, Ex. 8, and the control, Ex. 9. Gas chromatography and mass spec was used to determine the amount of the compounds shown in FIG. 8. The graph in FIG. 6 shows ratios of the concentrations of compounds present in the cocoa liquors of Ex. 7, Ex. 8, and the control, Ex. 9.

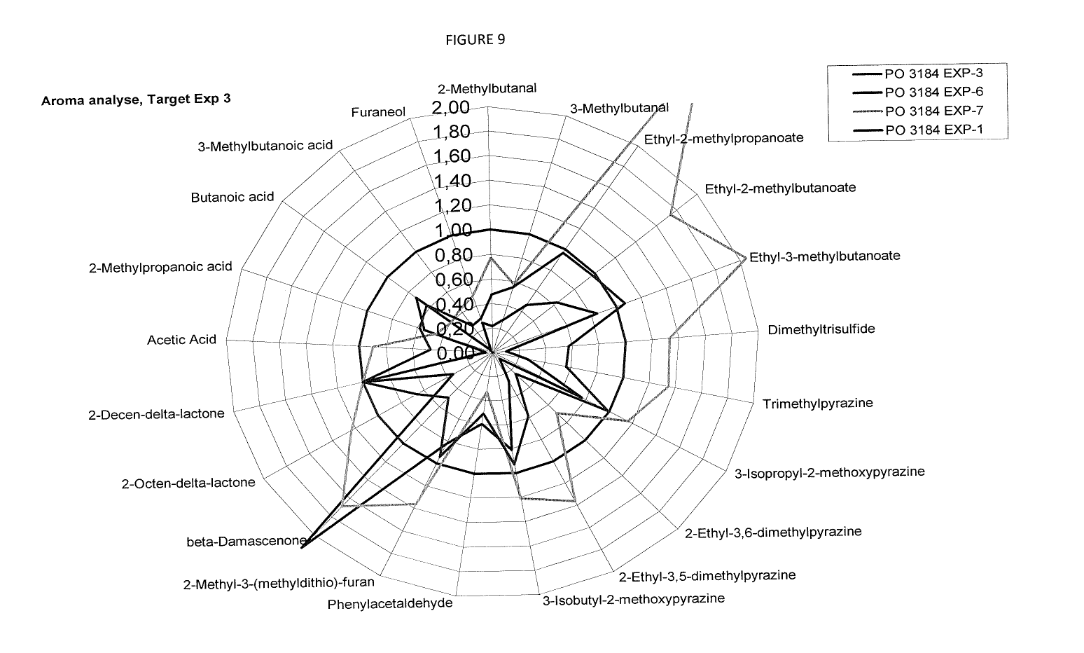

FIG. 9 shows a flavor profile of compounds present in the cocoa liquors produced in Ex. 1, Ex. 6, Ex. 7, and Ex. 3. Gas chromatography and mass spec was used to determine the amount of the compounds shown in FIG. 9. The graph in FIG. 9 shows ratios of the concentrations of compounds present in the cocoa liquors of Ex. 1, Ex. 6, Ex. 7, and Ex. 3.

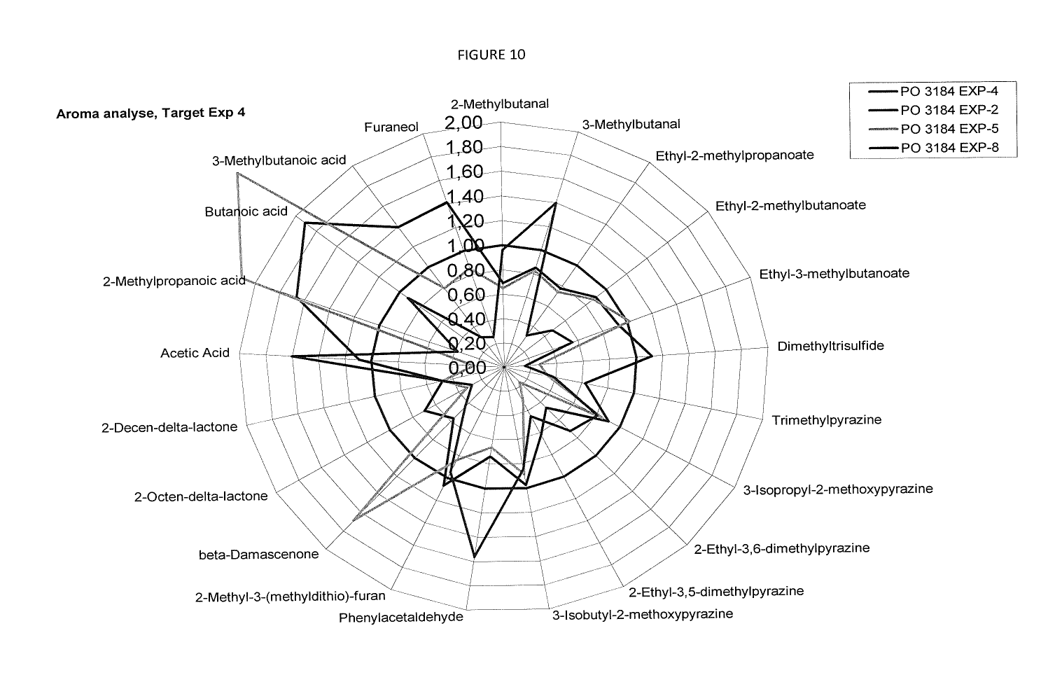

FIG. 10 shows a flavor profile of compounds present in the cocoa liquors produced in Ex. 2, Ex. 5, Ex. 8, and Ex. 4. Gas chromatography and mass spec was used to determine the amount of the compounds shown in FIG. 10. The graph in FIG. 10 shows ratios of the concentrations of compounds present in the cocoa liquors of Ex. 2, Ex. 5, Ex. 8, and Ex. 4.

### Example 10

### Production of Fruity Cocoa Products with Good Fermented Cocoa Beans

Good fermented cocoa beans were 50% Ghana and 50% Ivory Coast-1, and a reference sample of 100% Arriba beans was used.

Charges of 2.50 kg of cocoa nibs obtained from the cocoa beans were sterilized for 30 minutes in a box with open steam at a temperature of 101° C., +/−0.1° C. The steam flow capacity was 2.4 kg/hr and the injected steam pressure was almost 0.1 bar. The sterilized nibs having the temperature of 101° C. were loaded in a reactor with jacket heating where the temperature was reduced to 75-78° C. In the reactor, the nibs were heated to temperature of 90-95° C. using the jacket heating.

An acid solution having a temperature of 20° C. and 40° C. was added to the nibs in the reactor for the acidification process. The average reaction temperature of the nibs was 55-95° C. Nib samples were taken after a desired acidification (reaction) time.

The nib samples 10-15 were roasted in a Retch fluidized bed dryer, which is a laboratory scale jet roaster. The nib samples 16-21 were roasted in a Miag Spit which is a direct roasting. During roasting, the moisture content of the nibs was reduced from 20-30% down to 1-2%. The roasted nibs were first ground to coarse liquor with a household coffee mill and subsequently ground to cocoa liquor of a desired fineness with a Retsch laboratory mortal mill.

A first portion of the fine ground liquor was extracted to obtain fat free cocoa powder and a second portion of the fine ground liquor was hydraulic pressed into small cakes and filtered cocoa butter. The cakes were broken into smaller pieces which were pulverized into cocoa powder with a Retsch cutting mill using sieves of holes with 0.5 mm.

Samples 10-21 and the reference or control sample 22 were analyzed for: moisture content in the raw nib (before and after sterilization), the acidified nib, the roasted nib, and the cocoa liquor; pH of the liquor; aroma compound analysis of the liquor; and intrinsic color in water of the defatted liquor.

Tables 5A and 5B show process conditions and results for Samples 10-21. The reagents for Samples 10, 12, 14, and 17 were a phosphoric acid solution (0.64 M) and tap water, and the reagents for Samples 11, 13, 15, 16, and 28-21 were a gluconic delta lactone acid (GDL) solution (3.0 M) and tap water.

TABLE 5A

| Sample No. | 10 | 11 | 12 | 13 | 14 | 15 |
|---|---|---|---|---|---|---|
| % GDL added at | | 20 | | 20 | | 20 |
| 40° C. | | | | | | |
| % H3PO4 added | 20 | | 20 | | 20 | |
| at 20° C. | | | | | | |
| Reaction temp of | 55 | 55 | 55 | 55 | 55 | 55 |
| nibs in reactor | | | | | | |
| (° C.) | | | | | | |
| Reaction time (min) | 60 | 60 | 180 | 180 | 120 | 120 |
| Moisture content | | | | | | |
| of nibs (%) | | | | | | |
| Raw nib | 8.07 | 7.94 | 8.07 | 7.94 | 8.07 | 7.94 |
| After sterilization | 14.14 | 16.14 | 14.14 | 16.14 | 14.14 | 16.14 |
| After acidification | 27.27 | 25.17 | 26.16 | 24.95 | 27.06 | 23.63 |
| After Roasting | 2.97 | 3.12 | 2.47 | 3.50 | 2.14 | 2.75 |
| Liquor | | | | | | |
| pH | 4.82 | 4.88 | 4.54 | 4.56 | 4.61 | 4.64 |
| Moisture content | 0.8 | 0.82 | 0.92 | 0.78 | 0.88 | 0.83 |
| (%) | | | | | | |
| Jet roasting | X | X | X | X | X | X |
| (fluidized | | | | | | |
| bed dryer) | | | | | | |
| Miag Spit roasting | | | | | | |
| (direct contact | | | | | | |
| roasting) | | | | | | |

TABLE 5B

| Sample No. | 16 | 17 | 18 | 19 | 20 | 21 |
|---|---|---|---|---|---|---|
| % GDL added at | 20 | | 20 | 20 | 10 | 10 |
| 40° C. | | | | | | |
| % H₃PO₄ added | | 20 | | | | |
| at 20° C. | | | | | | |
| Reaction temp of | 55 | 55 | 80 | 80 | 80 | 80 |
| nibs in reactor | | | | | | |
| (° C.) | | | | | | |
| Reaction time (min) | 180 | 180 | 90 | 180 | 180 | 90 |
| Moisture content | | | | | | |
| of nibs (%) | | | | | | |
| Raw nib | 7.84 | 7.84 | 7.81 | 7.81 | 7.65 | 7.65 |
| After sterilization | 12.82 | 13.14 | 13.47 | 13.47 | 14.47 | 14.47 |
| After acidification | 23.57 | 25.45 | 23.36 | 22.83 | 18.55 | 19.14 |
| After Roasting | 2.49 | 2.78 | 3.24 | 3.60 | 3.73 | 3.16 |
| Liquor | | | | | | |
| pH | 4.66 | 4.56 | 4.81 | 4.40 | 4.86 | 4.88 |
| Moisture content | 0.80 | 0.82 | 0.78 | 0.82 | 0.70 | 0.80 |
| (%) | | | | | | |
| Jet roasting | | | | | | |
| (fluidized | | | | | | |
| bed dryer) | | | | | | |
| Miag Spit roasting | X | X | X | X | X | X |
| (direct contact | | | | | | |
| roasting) | | | | | | |

The amount of fruity aroma compounds in the liquor of Samples 10-21 and the control, Reference Sample 22, Arriba beans, was determined by GCMS analysis and the amount of such compounds are shown in Tables 6A and 6B. The amount of each compound is shown in μg/kg.

TABLE 6A

| Compound | Arriba | 10 | 11 | 12 | 13 | 14 | 15 |
|---|---|---|---|---|---|---|---|
| Ethyl-2-methylpropanoate | 1.61 | 14.69 | 9.91 | 6.95 | 10.40 | 10.02 | 9.62 |
| Ethyl-2-methylbutanoate | 4.42 | 30.17 | 22.03 | 18.23 | 26.36 | 21.29 | 22.75 |
| Ethyl-3-methylbutanoate | 6.93 | 38.54 | 28.83 | 22.94 | 33.80 | 26.89 | 28.93 |
| Phenylacetaldehyde | 23.71 | 23.64 | 55.27 | 51.29 | 51.63 | 70.25 | 54.25 |
| Furaneol | 73.65 | 1467.25 | 1729.10 | 866.13 | 1791.88 | 1770.40 | 852.40 |

TABLE 6B

| Compound | Arriba | 16 | 17 | 18 | 19 | 20 | 21 |
|---|---|---|---|---|---|---|---|
| Ethyl-2-methylpropanoate | 1.61 | 14.50 | 11.98 | 8.33 | 6.48 | 12.69 | 10.57 |
| Ethyl-2-methylbutanoate | 4.42 | 29.09 | 25.56 | 20.32 | 17.56 | 29.66 | 26.00 |
| Ethyl-3-methylbutanoate | 6.93 | 38.45 | 34.01 | 25.89 | 22.91 | 38.41 | 33.07 |
| Phenylacetaldehyde | 23.71 | 342.96 | 141.50 | 170.65 | 245.63 | 129.27 | 496.35 |
| Furaneol | 73.65 | 1967.78 | 1251.22 | 1763.02 | 1327.92 | 2927.81 | 1447.25 |

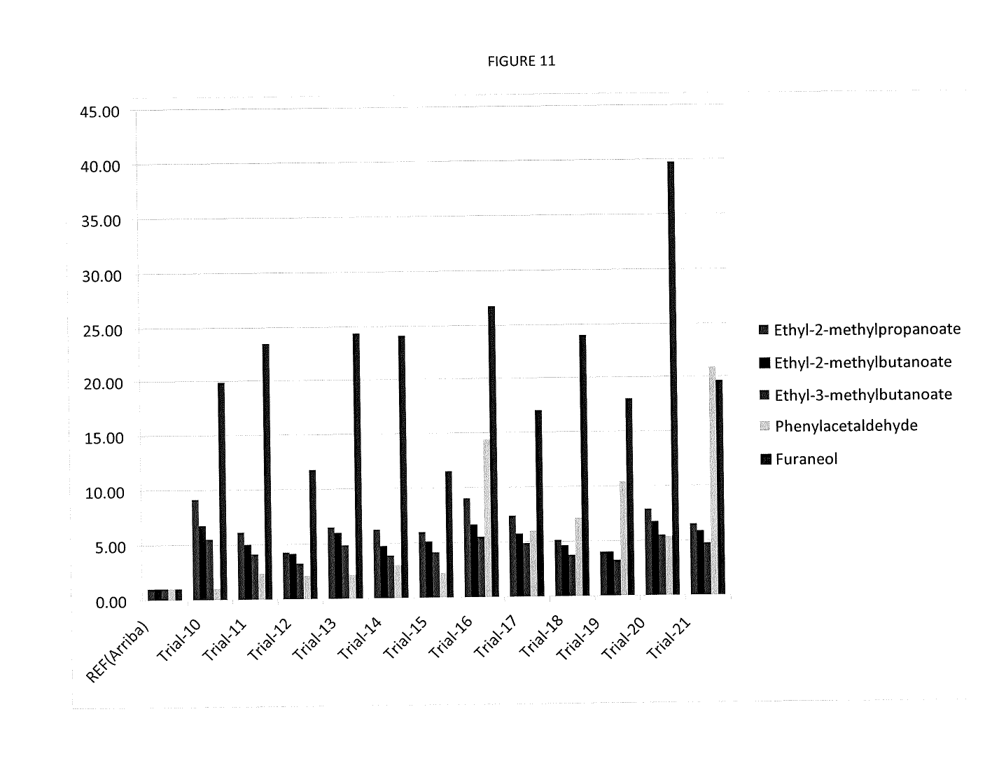

FIG. 11 shows the concentrations of the fruity compounds of Tables 6A and 6B in graphical form.

A ratio of the concentrations of the fruity compounds of Tables 6A and 6B using Arriba as a reference are shown in Tables 7A and 7B.

TABLE 7A

| Compound | Arriba | 10 | 11 | 12 | 13 | 14 | 15 |
|---|---|---|---|---|---|---|---|
| Ethyl-2-methylpropanoate | 1.00 | 9.14 | 6.17 | 4.32 | 6.47 | 6.23 | 5.98 |
| Ethyl-2-methylbutanoate | 1.00 | 6.83 | 4.99 | 4.13 | 5.97 | 4.82 | 5.15 |
| Ethyl-3-methylbutanoate | 1.00 | 5.56 | 4.16 | 3.31 | 4.88 | 3.88 | 4.18 |
| Phenylacetaldehyde | 1.00 | 1.00 | 2.33 | 2.16 | 2.18 | 2.96 | 2.29 |
| Furaneol | 1.00 | 19.92 | 23.48 | 11.76 | 24.33 | 24.04 | 11.57 |

TABLE 7B

| Compound | Arriba | 16 | 17 | 18 | 19 | 20 | 21 |
|---|---|---|---|---|---|---|---|
| Ethyl-2-methylpropanoate | 1.00 | 9.02 | 7.45 | 5.18 | 4.03 | 7.89 | 6.57 |
| Ethyl-2-methylbutanoate | 1.00 | 6.59 | 5.79 | 4.60 | 3.98 | 6.71 | 5.89 |
| Ethyl-3-methylbutanoate | 1.00 | 5.55 | 4.91 | 3.74 | 3.31 | 5.54 | 4.77 |
| Phenylacetaldehyde | 1.00 | 14.46 | 5.97 | 7.20 | 10.36 | 5.45 | 20.93 |
| Furaneol | 1.00 | 26.72 | 16.99 | 23.94 | 18.03 | 39.75 | 19.65 |

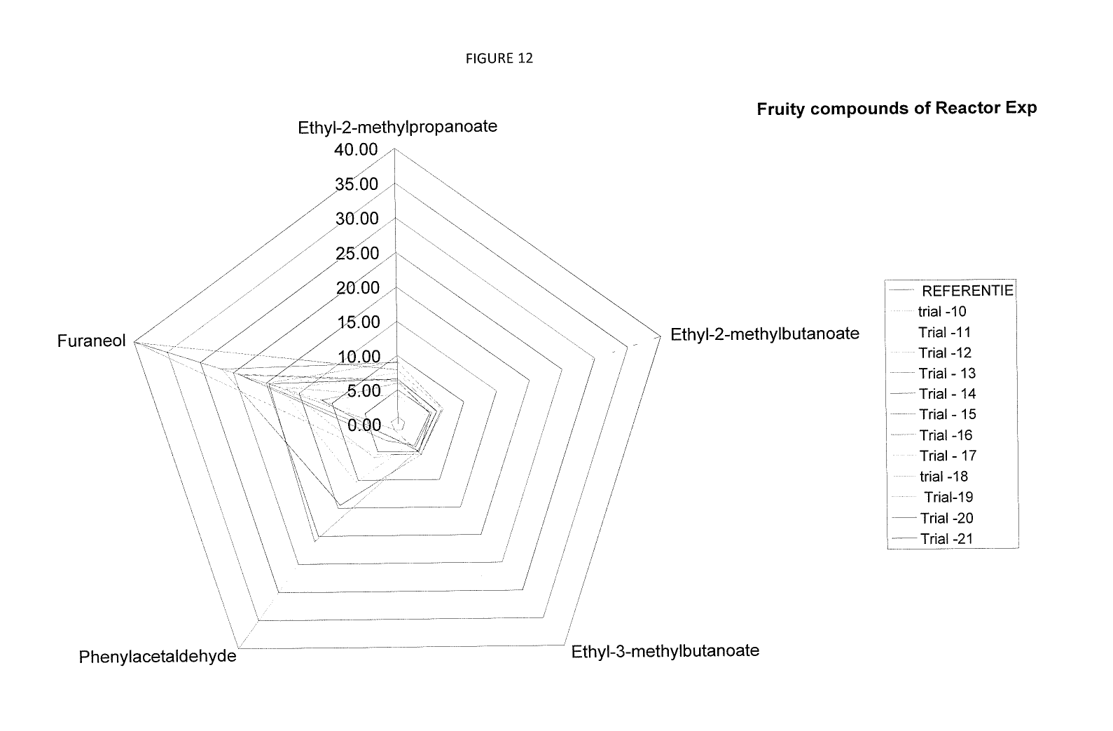

FIG. 12 shows a spider graph of the ratios of fruity compounds of Tables 7A and 7B.

### Example 11

### Compound Coatings Produced with Fruity Cocoa Products

Three compound coatings were produced using the fruity cocoa powder of Example 3. The formulations of the three compound coatings are shown in Tables 8-10.

TABLE 8
Yoghurt compound coating.

| | |
|---|---|
| Sugar | 41.00% |
| Palm Kernel Stearin | 34.00% |
| Whey Powder | 10.00% |
| fruity cocoa powder Example 3 | 6.50% |
| Lactose | 5.00% |
| lecithin | 0.50% |
| D-13 Yoghurt Powder | 3.00% |
| total | 100.00% |

TABLE 9
Compound coating with fruity cocoa powder.

| | |
|---|---|
| Sugar | 54.00% |
| Palm Kernel Stearin | 29.00% |
| fruity cocoa powder Example 3 | 16.50% |
| lecithin | 0.50% |
| total | 100.00% |

TABLE 10
Limon compound coating with fruity cocoa powder.

| | |
|---|---|
| Sugar | 53.85% |
| Palm Kernel Stearin | 29.00% |
| fruity cocoa powder Example 3 | 16.50% |
| lecithin | 0.50% |
| Lime flavouring | 0.15% |
| total | 100.00% |

A sensory test was done to compare the limon compound coating of Table 10 produced with the fruity cocoa powder of Example 3 and a reference limon compound coating made with commercially available cocoa powder using the formulation of Table 10. The limon compound coating with the fruity cocoa powder had more acidity/fruity flavors, more bitterness, more bouquet, more sweet, and more aromatic flavors as compared to the reference limon compound coating using the commercially available cocoa powder.

### Example 12

### Production of Fruity Cocoa Products with Good Fermented Cocoa Beans Using Various Acids

Good fermented cocoa beans were 50% Ghana and 50% Ivory Coast-1.

The cocoa products produced in this Example were produced in substantially the same manner as the process described in Example 10, but using the acids in the amounts listed in Table 11.

TABLE 11
Acids and color values of powders.

| Sample | L-value | C-value | H-value | a-value | b-value | pH |
|---|---|---|---|---|---|---|
| Reference - | 24.88 | 28.59 | 55.34 | 16.26 | 23.62 | 5.82 |
| natural, not | | | | | | |
| treated with | | | | | | |
| acid or alkali | | | | | | |
| Ascorbic acid | 25.23 | 29.35 | 53.80 | 17.33 | 23.68 | 4.46 |
| 0.5M | | | | | | |
| H₃PO₄ (1.55%) - | 26.65 | 27.58 | 53.68 | 16.33 | 22.22 | 4.67 |
| by weight | | | | | | |
| NaHSO₄ (5.7%) - | 24.02 | 29.08 | 49.97 | 18.70 | 22.27 | 3.50 |
| by weight | | | | | | |
| GDL (0.5M) | 24.57 | 27.37 | 53.37 | 16.33 | 21.97 | 4.56 |

### Example 13

### Production of Fruity Cocoa Products with Good Fermented Cocoa Beans Using Gluconic Acid

Good fermented cocoa beans were 50% Ghana and 50% Ivory Coast-1.

Charges of 10,000 kg of cocoa nibs obtained from the cocoa beans were pre-heated with open steam pressure of 0.5 bar to a temperature of 100-105° C. for 3-5 minutes. The 10,000 kg, pre-heated cocoa nib charges were placed into five different blenders and sterilized for 30 minutes with open steam at a steam pressure of 0.5 bar and a temperature of 100-105° C. After sterilization, 10% by weight of a 50% by weight solution of gluconic acid delta lactone having a temperature of 27-30° C. was added to the cocoa nibs in the blender and the acidification process was started. The addition of the gluconic acid delta lactone solution slowly dropped the temperature of the cocoa nibs from 95° C. to 88° C. No steam was added during the acidification process.

No air was injected into blenders 1-4 during the acidification process and blender 5 did have air injected. The acidification time was 90 minutes and the average reaction temperature of the nibs during the acidification process was 75-90° C. for blenders 1-4. In blender 5, air was injected for 45 minutes according to the following schedule: 0-15 minutes, no air injection; 15-30 minutes, air was injected; 30-45 minutes, no air injection; 45-60 minutes, air was injected; 60-75 minutes, no air injection; and 75-90 minutes, air was injected.

The acidified nibs were roasted with a constant capacity of 4500 kg/hr. The roasted nibs were ground in a Buhler mill and a ball mill to produce cocoa liquor of the desired fineness. The pH, moisture content, intrinsic color in water of the defatted liquor, and presence of fruity flavor compounds were measured for the cocoa liquor. The cocoa liquor was also pressed into dry cakes having about 11% fat, and the dry cakes were also processed into cocoa powder. The pH, moisture content, intrinsic color in water, and presence of fruity flavor compounds were measured for the cocoa powder. During the process, samples were taken every hour.

A summary of the process conditions; pH, moisture content, and fat content of the cocoa liquor; and free fatty acid and iodine value of the cocoa butter produced are shown in Table 12.

TABLE 12
Process conditions and results of measurements.

| Blender No. | 1 | 2 | 3 | 4 | 5 |
|---|---|---|---|---|---|
| Acidification time (minutes) | 90 | 90 | 90 | 90 | 90 |
| Gluconic acid (50% by weight solution) | 10 | 10 | 10 | 10 | 10 |
| added | | | | | |
| Blower time (minutes) | 0 | 0 | 0 | 0 | 45 |
| Nibs | | | | | |
| Moisture content of raw nib (%) | 7 | 7 | 7 | 7 | 7 |
| Moisture content of acidified nib (%) | 15.9 | 14.34 | 14.07 | 14.35 | 12.63 |
| Moisture content after 2^{nd} dryer (%) | 2.0-2.5 | 2.0-2.5 | 2.0-2.5 | 2.0-2.5 | 2.0-2.5 |
| Moisture content after nib cooler (%) | 1.90 | 1.80 | 1.60 | 1.70 | 1.70 |
| Cocoa liquor produced | | | | | |
| pH | 4.7 | 4.6 | 4.5 | 4.4 | 4.4 |
| Moisture content (%) | 1.2 | 1.1 | 1.1 | 1.1 | 1 |
| Fat content (%) | 51.3 | 51.6 | 52.2 | 51.9 | 51.5 |
| Butter produced | | | | | |
| Free Fatty Acid (%) | 1.7 | 1.7 | 1.7 | 1.6 | 1.6 |
| Iodine Value | 34.3 | 34.3 | 34.3 | 34.3 | 34.3 |

A summary of the percent moisture in the nib and liquor, percent fat in the liquor, pH of the liquor, and intrinsic color of the liquor in water are shown in Table 13.

TABLE 13
Analysis of the cocoa liquor produced at various time intervals during the process.

| | Sampling time | | | | | | | | |
|---|---|---|---|---|---|---|---|---|---|
| | Start of | | | | | | | | Reference Sample |
| | process | 1 hour | 2 hours | 3 hours | 4 hours | 5 hours | 6.5 hours | 6.75 hou [symbol] | Natural liquor |
| % moisture | 2.33 | 1.61 | 1.74 | 2.13 | 1.66 | 1.56 | 1.92 | 1.68 | 1.5 |
| in nib after | | | | | | | | | |
| nib cooler | | | | | | | | | |
| % moisture | 1.27 | 1.06 | 1.03 | 1.08 | 1.07 | 1.08 | 1.08 | 1.01 | 1.01 |
| in liquor | | | | | | | | | |
| produced | | | | | | | | | |
| % fat in | 50.61 | 52.01 | 51.25 | 52.1 | 52.1 | 52.37 | 51.9 | 51.52 | 54.89 |
| liquor | | | | | | | | | |
| pH liquor | 4.84 | 4.61 | 4.55 | 4.57 | 4.46 | 4.41 | 4.43 | 4.40 | 5.58 |
| Intrinsic | | | | | | | | | |
| color in | | | | | | | | | |
| water | | | | | | | | | |
| L | 23.30 | 24.23 | 24.35 | 24.84 | 24.87 | 24.78 | 24.74 | 24.90 | 26.42 |
| C | 23.49 | 24.05 | 24.41 | 24.64 | 24.54 | 24.93 | 25.08 | 24.81 | 24.80 |
| H | 53.90 | 54.23 | 52.24 | 54.49 | 54.51 | 53.82 | 53.97 | 54.12 | 54.42 |
| a | 13.84 | 14.06 | 14.26 | 14.31 | 14.25 | 14.72 | 14.75 | 14.54 | 14.43 |
| b | 18.98 | 19.51 | 19.81 | 20.06 | 19.98 | 20.12 | 20.28 | 20.10 | 20.17 |

[symbol]

indicates data missing or illegible when filed

The average pH of the cocoa liquor during the run was about 4.65, the average fat content in the cocoa liquor during the run was about 51.7%, the average moisture content of the nib after the nib cooler was about 1.82%, and the average moisture content of the liquor produced during the run was about 1.08%. The color values of the cocoa liquor produced are comparable with those of the reference, natural liquor.

A summary of the percent moisture in the cocoa powder, percent fat in the cocoa powder, pH of the cocoa powder, and intrinsic color of the cocoa powder in water are shown in Table 13.

TABLE 13
Analysis of the cocoa powder produced at various time intervals during the
process, “ffd” refers to fat free dry matter or fat free cocoa powder.

| | Sampling time | | | | | | | | |
|---|---|---|---|---|---|---|---|---|---|
| | Start of | | | | | | | | Reference Sample |
| | process | 1 hour | 2 hours | 3 hours | 4 hours | 5 hours | 6.5 hours | 6.75 hou [symbol] | Natural liquor |
| % moisture | 3.45 | 3.04 | 2.99 | 3.57 | 3.91 | 3.02 | 2.79 | 2.53 | 4.04 |
| powder | | | | | | | | | |
| % fat in | 12.48 | 11.50 | 10.69 | 10.74 | 10.70 | 10.93 | 11.35 | 11.31 | 20.80 |
| powder | | | | | | | | | |
| pH powder | 4.72 | 4.54 | 4.47 | 4.52 | 4.45 | 4.48 | 4.47 | 4.60 | 5.60 |
| Intrinsic | | | | | | | | | |
| color in | | | | | | | | | |
| water of | | | | | | | | | |
| powder | | | | | | | | | |
| L | 21.78 | 23.21 | 23.87 | 25.21 | 23.85 | 23.96 | 23.94 | 24.84 | 25.72 |
| C | 23.35 | 23.81 | 24.51 | 26.35 | 24.21 | 24.90 | 24.89 | 26.44 | 25.18 |
| H | 52.99 | 53.70 | 53.70 | 53.49 | 54.00 | 53.31 | 53.33 | 54.09 | 54.06 |
| a | 14.06 | 14.11 | 14.51 | 15.68 | 14.23 | 14.88 | 14.87 | 15.51 | 14.78 |
| b | 18.65 | 19.21 | 19.75 | 21.18 | 19.58 | 19.97 | 19.96 | 21.51 | 20.39 |
| Intrinsic | | | | | | | | | |
| color in | | | | | | | | | |
| water of | | | | | | | | | |
| ffd powder | | | | | | | | | |
| L | 19.82 | 21.39 | 22.14 | 23.36 | 22.00 | 22.19 | 22.15 | 23.06 | 22.30 |
| C | 22.41 | 22.99 | 23.72 | 25.50 | 23.36 | 24.09 | 24.07 | 25.60 | 23.67 |
| H | 52.72 | 53.42 | 53.43 | 53.17 | 53.71 | 53.03 | 53.04 | 53.78 | 53.50 |
| a | 13.57 | 13.70 | 14.13 | 15.29 | 13.83 | 14.49 | 14.47 | 15.12 | 14.08 |
| b | 17.83 | 18.46 | 19.05 | 20.41 | 18.83 | 19.24 | 19.23 | 20.65 | 19.03 |

[symbol]

indicates data missing or illegible when filed

The average pH of the cocoa powder produced from the cocoa liquor was about. 4.53. The color values of the cocoa powder produced are comparable to those of the reference sample, natural liquor.

A summary of cocoa powders and pulverized cakes made from cocoa liquors during the process are shown in Table 14.

TABLE 14
Comparison of cocoa powders produced.

| Sample | | | | | | | | | |
|---|---|---|---|---|---|---|---|---|---|
| Description | % moisture | % fat | pH | L ffd | C ffd | H ffd | L | C | H |
| Pulverized cakes | 3.08 | 11.71 | 4.53 | 21.48 | 23.76 | 53.87 | 23.03 | 24.65 | 54.15 |
| Made from liquor | | | | | | | | | |
| at 3 hours after | | | | | | | | | |
| process began | | | | | | | | | |
| Pulverized cakes | 2.69 | 10.58 | 4.48 | 22.36 | 24.73 | 53.74 | 24.04 | 25.52 | 53.91 |
| Made from liquor | | | | | | | | | |
| at 6.75 hours after | | | | | | | | | |
| Process began | | | | | | | | | |
| Pulverized cakes | 2.98 | 11.03 | 4.64 | 20.7 | 24.1 | 54.04 | 22.42 | 24.98 | 54.30 |
| from one press | | | | | | | | | |
| machine | | | | | | | | | |
| Pulverized cakes | 3.06 | 12.64 | 4.64 | 20.68 | 24.62 | 53.95 | 22.63 | 25.63 | 54.25 |
| from other press | | | | | | | | | |
| machine | | | | | | | | | |
| Pulverized cakes | 3.41 | 12.64 | 5.20 | 18.44 | 22.19 | 53.74 | 20.30 | 23.18 | 53.99 |
| From one | | | | | | | | | |
| batchmaker | | | | | | | | | |
| Pulverized cakes | 3.05 | 12.34 | 4.94 | 19.33 | 22.92 | 53.91 | 21.19 | 23.88 | 54.17 |
| From other | | | | | | | | | |
| batchmaker | | | | | | | | | |
| Final powder from | 4.40 | 12.38 | 4.85 | 19.48 | 23.34 | 53.89 | 21.54 | 24.41 | 54.18 |
| One batchmaker | | | | | | | | | |
| Final powder from | 4.70 | 12.73 | 5.05 | 18.30 | 22.57 | 53.52 | 20.39 | 23.69 | 53.82 |
| Other batchmaker | | | | | | | | | |
| Reference Sample | 4.40 | 20.80 | 5.6 | 22.30 | 23.67 | 53.50 | 25.72 | 25.18 | 54.06 |

The microbiological results of the final powders produced were good and all within commercially acceptable limits for cocoa powders.

An SGS analysis on a cocoa powder produced is shown in Table 15.

TABLE 15
SGS analysis on cocoa powder.

| | |
|---|---|
| Ash content (%) | 6.59 |
| Total alkalinity (ml/100 g) | 83.67 |
| Total iron as Fe (mg/kg) | 280 |
| Potassium as K (%) | 2.5 |
| Sodium as Na (%) | 0.005 |
| Aluminum as Al (mg/kg) | 89 |
| Silicium as Si (%) | <0.01 |
| Citric acid (%) | 0.97 |
| Acetic acid (%) | 0.45 |
| Lactic acid (%) | 0.33 |
| OchraToxin A (μg/kg) | 0.3 |
| Acrylamide (μg/kg) | 230 |

The values of Fe, Al, Si, and acrylamide in the cocoa powders of the present invention are much lower than those measured in natural powders typically produced.

The quality of the cocoa butters produced according to this example is good and within commercially acceptable limits.

A ratio of the concentrations of the fruity compounds of the cocoa liquor produced at various timepoints during the process compared to the reference, Arriba is shown in Table 16. The fruity flavor compounds were present in the cocoa liquor at between about: 3.28-4.26 μg/kg of ethyl-2-methylpropanoate; 9.37-10.82 μg/kg of ethyl-2-methylbutanoate; 12.95-14.55 μg/kg of ethyl-3-methylbutanoate; 220.03-269.58 μg/kg of phenylacetaldehyde; and 1257.21-1938.47 μg/kg of furaneol.

TABLE 16
Fruity compound analysis, Arriba as reference.

| | Sample | | | | | | | | |
|---|---|---|---|---|---|---|---|---|---|
| | | 1 | 2 | 3 | 4 | 5 | 6 | 7 | 8 |
| | | Time (hr) | | | | | | | |
| | | Start of | | | | | | | |
| | | Process | | | | | | | |
| | Arriba | 15:30 hr | 1 hr | 2 hrs | 3 hrs | 4 hrs | 5 hrs | 6.5 hrs | 6.75 hrs |
| Ethyl-2-methylpropanoate | 1 | 2.43 | 2.62 | 2.43 | 2.04 | 2.37 | 2.51 | 2.65 | 2.27 |
| Ethyl-2-methylbutanoate | 1 | 2.22 | 2.36 | 2.45 | 2.32 | 2.31 | 2.29 | 2.36 | 2.12 |
| Ethyl-3-methylbutanoate | 1 | 1.95 | 2.07 | 2.10 | 2.06 | 1.99 | 1.96 | 2.05 | 1.87 |
| phenylacetaldehyde | 1 | 10.31 | 11.37 | 10.87 | 10.21 | 9.28 | 9.37 | 10.85 | 9.81 |
| furaneol | 1 | 17.07 | 21.49 | 24.73 | 23.39 | 26.32 | 20.09 | 23.66 | 22.92 |

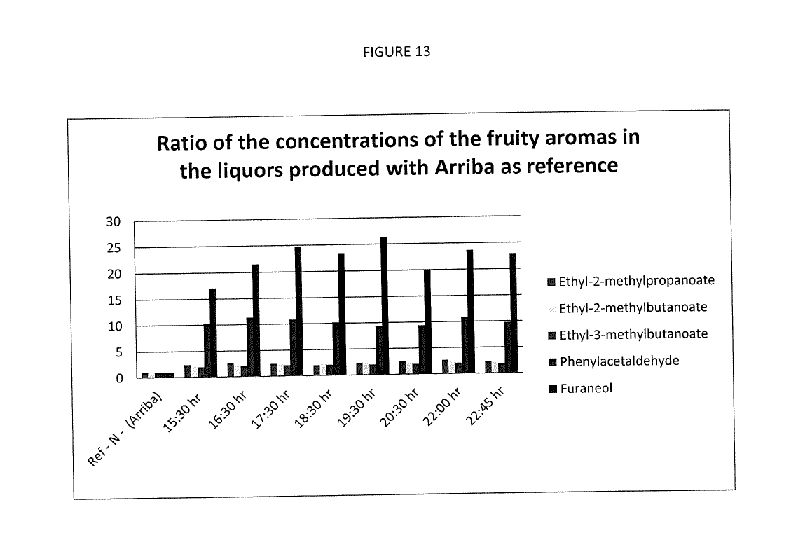

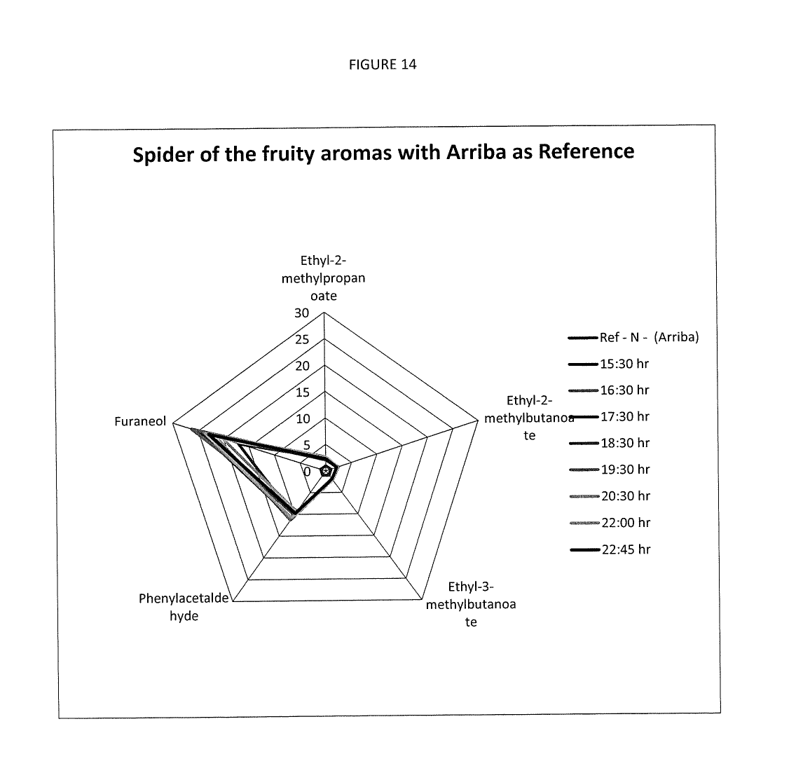

FIG. 13 shows a graph of the ratio of the concentrations of the fruity compounds of Table 16, and a spider graph of the concentrations of Table 16 is shown in FIG. 14.

A ratio of the concentrations of the fruity compounds of the cocoa liquor produced at various timepoints during the process compared to the reference, a natural liquor of 50% Ghana and 50% Ivory Coast beans is shown in Table 17.

TABLE 17
Fruity compound analysis, natural liquor as reference.

| | Sample | | | | | | | | |
|---|---|---|---|---|---|---|---|---|---|
| | | 1 | 2 | 3 | 4 | 5 | 6 | 7 | 8 |
| | | Time (hr) | | | | | | | |
| | | Start of | | | | | | | |
| | Natural | Process | | | | | | | |
| | liquor | 15:30 hr | 1 hr | 2 hrs | 3 hrs | 4 hrs | 5 hrs | 6.5 hrs | 6.75 hrs |
| Ethyl-2-methylpropanoate | 1 | 27.59 | 29.77 | 27.58 | 23.13 | 26.96 | 28.44 | 30.13 | 25.73 |
| Ethyl-2-methylbutanoate | 1 | 5.40 | 6.58 | 6.35 | 4.88 | 7.55 | 5.68 | 6.42 | 5.89 |
| Ethyl-3-methylbutanoate | 1 | 4.69 | 4.88 | 5.65 | 4.43 | 5.46 | 4.70 | 5.37 | 5.00 |
| phenylacetaldehyde | 1 | 27.59 | 29.77 | 27.58 | 23.13 | 26.96 | 28.44 | 30.13 | 25.73 |
| furaneol | 1 | 30.77 | 32.69 | 33.97 | 32.07 | 31.97 | 31.75 | 32.69 | 29.40 |

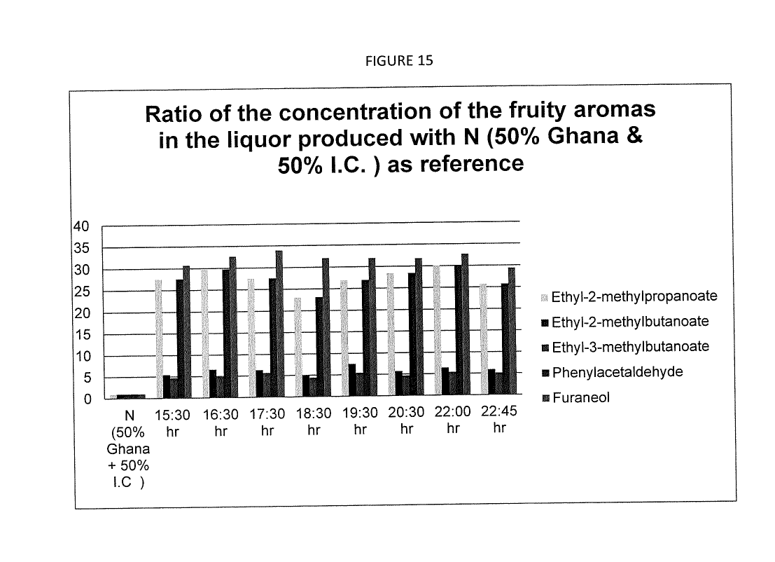

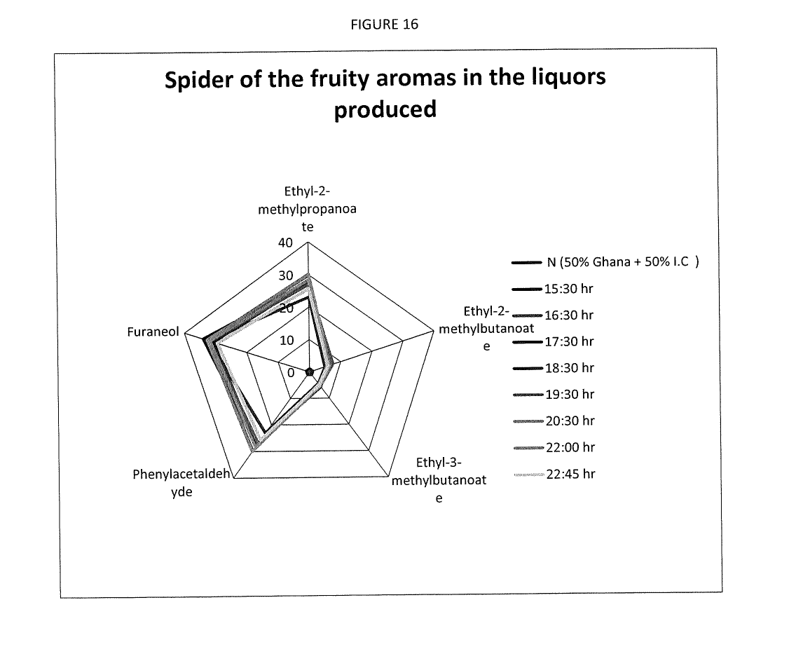

FIG. 15 shows a graph of the ratio of the concentrations of the fruity compounds of Table 16, and a spider graph of the concentrations of Table 17 is shown in FIG. 16.

A ratio of the concentrations of the fruity compounds of the cocoa liquor obtained from nibs from the nib cooler produced at various timepoints during the process compared to the reference, Arriba is shown in Table 18. The fruity flavor compounds were present in the cocoa liquor at between about: 4.63-8.85 μg/kg of ethyl-2-methylpropanoate; 17.02-20.55)μg/kg of ethyl-2-methylbutanoate; 23.15-27.44 μg/kg of ethyl-3-methylbutanoate; 316.53-435.79 μg/kg of phenylacetaldehyde; and 1710.89-2366.37 μg/kg of furaneol.

TABLE 18
Fruity compound analysis of cocoa nibs from nib cooler, Arriba as reference.

| | Sample | | | | | | | | |
|---|---|---|---|---|---|---|---|---|---|
| | | 1 | 2 | 3 | 4 | 5 | 6 | 7 | 8 |
| | | Time (hr) | | | | | | | |
| | | Start of | | | | | | | |
| | | Process | | | | | | | |
| | Arriba | 15:30 hr | 1 hr | 2 hrs | 3 hrs | 4 hrs | 5 hrs | 6.5 hrs | 6.75 hrs |
| Ethyl-2-methylpropanoate | 1 | 5.50 | 5.05 | 4.97 | 3.79 | 2.88 | 5.31 | 4.37 | 3.40 |
| Ethyl-2-methylbutanoate | 1 | 4.65 | 4.22 | 4.58 | 4.28 | 3.85 | 4.65 | 3.86 | 3.91 |
| Ethyl-3-methylbutanoate | 1 | 3.93 | 3.64 | 3.93 | 3.70 | 3.37 | 3.96 | 3.34 | 3.42 |
| phenylacetaldehyde | 1 | 13.36 | 13.77 | 15.35 | 13.35 | 15.15 | 15.90 | 18.35 | 15.82 |
| furaneol | 1 | 23.23 | 26.20 | 32.13 | 26.73 | 26.12 | 29.80 | 26.28 | 27.24 |

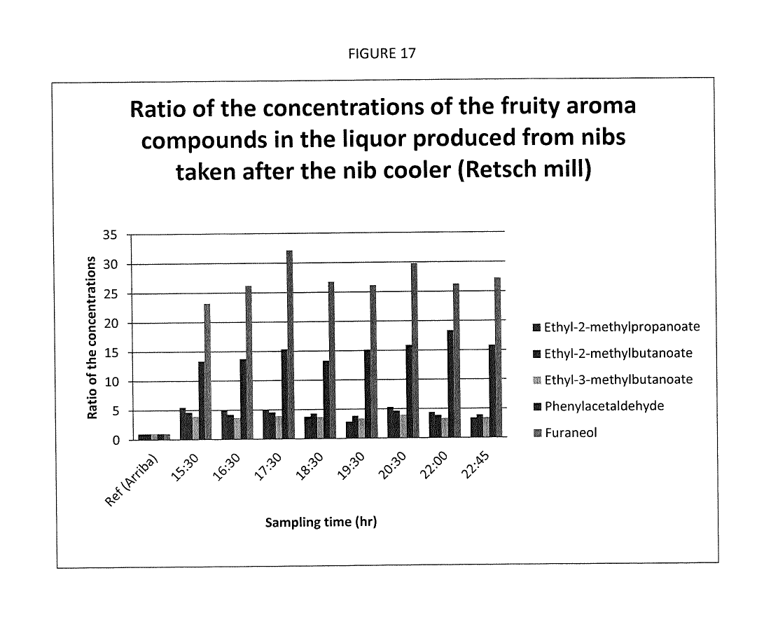

FIG. 17 shows a graph of the ratio of the concentrations of the fruity compounds of Table 18.

### Example 14

### Production of Dark Chocolate with Fruity Flavored Cocoa Products

Dark chocolate was made with the following ingredients: 37.18% of a fruity flavored cocoa liquor of the present invention; 22.46% of cocoa butter; 14% of a fruity flavored cocoa powder of the present invention; 25.85% of sugar; 0.5% of soy lecithin; and 0.01% of vanillin. The dark chocolate was about 72% cocoa. The chocolate was produced using a method conventionally known by one of ordinary skill in the art.

Dark chocolate was made with the following ingredients: 49.75% of a fruity flavored cocoa liquor of the present invention; 49.74% of sugar; 0.5% of soy lecithin; and 0.01% of natural vanilla. The dark chocolate was about 48% cocoa. The chocolate was produced using a method conventionally known by one of ordinary skill in the art.

Dark chocolate was made with the following ingredients: 64.5% of a fruity flavored cocoa liquor of the present invention; 9% of cocoa butter; 26% of sugar; and 0.5% of sunflower lecithin. The dark chocolate was about 71% cocoa. The chocolate was produced using a method conventionally known by one of ordinary skill in the art.

Dark chocolate with a raspberry powder was made with the following ingredients: 37.18% of a fruity flavored cocoa liquor of the present invention; 22.46% of cocoa butter; 5% of a raspberry powder; 14% of a fruity flavored cocoa powder of the present invention; 20.85% of sugar; 0.5% of soy lecithin; and 0.01% of vanillin. The raspberry flavored chocolate was about 72% cocoa. The chocolate was produced using a method conventionally known by one of ordinary skill in the art.

### Example 14

### Production of a Filling

A yoghurt/strawberry filling was made with the following ingredients: 31.35% of a cocoa butter equivalent (CBE); 7.5% of skimmed milk powder; 3% of whole milk powder; 2% of strawberry flakes; 7.5% of whey powder; 0.6% of lactose; 47.4% of sugar; 0.6% of soy lecithin; and 0.05% of natural vanilla. The filling was produced using a method conventionally known by one of ordinary skill in the art.

### Example 15

### Production of a Candy with a Fruity Flavored Cocoa Product

Pralines were produced using the yoghurt/strawberry filling of Example 14 and a chocolate of Example 13 as a shell using techniques known by those of ordinary skill in the art.

### Example 16

### Production of a Candy with a Fruity Flavored Cocoa Product

A yogurt/cocoa filling was produced using between 3-7% of a fruity flavored cocoa powder of the present invention. A praline was produced using the yogurt/cocoa filling and a chocolate of Example 13 as a shell.

### Example 17

### Production of a Cake with a Fruity Flavored Cocoa Product

A cake was produced with the following ingredients: 250 grams of egg; 170 grams of sugar; 80 grams of flour; 80 grams of cornstarch; and 20 grams of a fruity flavored cocoa powder of the present invention. The cake was produced using a technique known by one of ordinary skill in the art.

### Example 18

### Production of a Cheesecake with a Fruity Flavored Cocoa Product

Cheesecakes were produced with the following ingredients: 575 grams of curt cheese; 5 grams of egg yolk; 57.5 grams of flour; 76 grams of cornstarch; a sufficient quantity of milk; 5 grams of egg whites; 115 grams of sugar; and 2.5-10% of a fruity flavored cocoa powder of the present invention. The cheesecakes were produced using techniques known by those of ordinary skill in the art.

### Example 19

### Production of a Chocolate Filling

A chocolate filling was produced with the following ingredients: 38.9% of sugar; 5% of sunflower oil; 10% of whey powder; 22.5% of palm oil; 8% of white lactose; 7% of a fruity cocoa liquor of the present invention; 5% of skimmed milk powder; 3% of a fruity cocoa powder of the present invention; and 0.6% of soy lecithin. The chocolate filling was produced using techniques known by those of ordinary skill in the art.

This disclosure has been described with reference to certain exemplary embodiments, compositions and uses thereof. However, it will be recognized by those of ordinary skill in the art that various substitutions, modifications or combinations of any of the exemplary embodiments may be made without departing from the spirit and scope of the disclosure. Thus, the disclosure is not limited by the description of the exemplary embodiments, but rather by the appended claims as originally filed.

1. A cocoa product selected from the group consisting of a cocoa powder, a cocoa liquor, and a cocoa butter, the cocoa product having a fruity flavor comprising:
an increased amount of a fruity aroma compounds.

2. The cocoa product of claim 1, wherein the fruity aroma compounds are selected from the group consisting of furaneol, phenylacetaldehyde, ethyl-2-methylpropanoate, ethyl-2-methylbutanoate, ethyl-2-methylbutanoate, and combinations of any thereof.

3. (canceled)

4. The cocoa product of claim 1, wherein the cocoa product comprises an amount of fruity aroma compounds selected from the group consisting of at least 2.5 μg/kg of ethyl-2-methylpropanoate, at least 7.5 μg/kg of ethyl-2-methylbutanoate, at least 10 μg/kg of ethyl-3-methylbutanoate, at least 50 μg/kg of phenylacetaldehyde at least 100 μg/kg of furaneol, and combinations of any thereof.

5. The cocoa product of claim 1, wherein the cocoa product is the cocoa powder.

6. The cocoa product of claim 1, wherein the cocoa product is the cocoa liquor.

7. (canceled)

8. The cocoa product of claim 1, wherein the cocoa product has a color value selected from the group consisting of an L value of between about 18 to about 29, a C value of about 23 to about 30, an H value of between about 35 to about 55, and combinations of any thereof.

9. The cocoa product of claim 1, wherein the cocoa product has a pH of between about 4.5 to about 6.

10-11. (canceled)

12. The cocoa product of claim 1, wherein the cocoa product originates from un-fermented cocoa beans, under fermented cocoa beans, good fermented cocoa beans, or combinations of any thereof.

13. The cocoa product of claim 1, wherein the cocoa product originates from good fermented cocoa beans.

14-15. (canceled)

16. A method for producing a cocoa product having a fruity flavor of, the method comprising:
mixing cocoa nibs, de-shelled cocoa beans, or a combination thereof with an acid and water; and roasting the acidified nibs, the acidified, de-shelled cocoa beans, or the combination thereof.

17. The method according to claim 16, further comprising washing the acidified cocoa nibs, the acidified de-shelled cocoa beans, or the combination thereof with water.

18. The method according to claim 16, wherein the acid is selected from the group consisting of gluconic delta lactone acid, phosphoric acid, ascorbic acid, sodium bisulphate acid, and combinations is of any thereof.

19-20. (canceled)

21. The method according to claim 16, further comprising sterilizing the cocoa nibs, the de-shelled cocoa beans, or the combination thereof.

22. The method according to claim 16, wherein the nibs, the de-shelled cocoa beans, or the combination thereof are in contact with the acid and water for a time of between about 0.5 to about 4 hours.

23. The method according to claim 16, wherein the nibs, the de-shelled cocoa beans, or the combination thereof are in contact with the acid and the water at a temperature of between about 15° C. and about 90° C.

24. The method according to claim 16, further comprising grinding the roast nibs, the roast de-shelled cocoa beans, or the combination thereof thus producing cocoa liquor.

25. The method according to claim 24, further comprising separating the cocoa liquor into cocoa butter and cocoa presscake.

26. The method according to claim 25, further comprising grinding the cocoa presscake into cocoa powder.

27-28. (canceled)

29. The method according to claim 16, where the roasted, acidified nibs, the roasted, acidified de-shelled cocoa beans, or the combination thereof comprise an amount of fruity aroma compounds selected from the group consisting of at least 2.5 μg/kg of ethyl-2-methylpropanoate, at least 7.5 μg/kg of ethyl-2-methylbutanoate, at least 10 μg/kg of ethyl-3-methylbutanoate, at least 50 μg/kg of phenylacetaldehyde, at least 100 μg/kg of furaneol, and combinations of any thereof.

30. (canceled)

31. The method according to claim 16, wherein the nibs, the de-shelled cocoa beans, or the combination thereof in the acid and water have a pH of between about 4.5 to about 6.
